(19) United States
(12) Patent Application Publication
(10) Pub. No.: US 2012/0059662 A1
(43) Pub. Date: Mar. 8, 2012

(54) AUTOMATED LEAD PROCESSING SYSTEMS AND METHODS

(76) Inventor: John E. Huisman, JR., Raleigh, NC (US)

(21) Appl. No.: 13/226,486

(22) Filed: Sep. 6, 2011

Related U.S. Application Data
(60) Provisional application No. 61/511,665, filed on Jul. 26, 2011.
(60) Provisional application No. 61/379,728, filed on Sep. 3, 2010.

(51) Int. Cl. G06Q 10/00

(52) U.S. Cl. 705/1.1

(57) ABSTRACT

A computer-implemented automated lead processing system and method for lead development, the system including a lead set comprising lead data for one or more potential leads; and a table-driven customizable campaign interface for selection of a sequence of lead development steps applicable to said one or more potential leads, to initiate automated processing of said lead data in said lead set for said one or more potential leads, and to generate a monitoring record in a database of the system of said sequence of lead development steps, wherein the system is adapted on occurrence of at least one predefined trigger event to signal at least one action to be taken relating to the sequence of lead development steps, and wherein the system is adapted to display a status determination on said interface for said one or more potential leads, and automatically initiate a response to a trigger event if so desired.

### CROSS REFERENCE TO RELATED APPLICATIONS

The benefit of priority of U.S. Provisional Patent Application No. 61/379,728 filed on Sep. 3, 2010 and U.S. Provisional Patent Application No. 61/511,665 filed on Jul. 26, 2011 in the name of John E. Huisman for “AUTOMATED LEAD PROCESSING SYSTEMS AND METHODS” is hereby claimed under the provisions of 35 USC 119.

### FIELD

The present disclosure relates to systems and methods for automated lead processing.

### BACKGROUND

The development of computer programs and systems incorporating automated sales processes has improved the generation and processing of sales leads, particularly when coupled with the internet. Leads as used herein are generally understood as people or entities potentially interested in purchasing a product or service, but may also encompass individuals of interest to a charity, political organization, school booster club, employee (e.g., seeking employment), or any entity that may be seeking contact with one or more individuals for a variety of reasons, including but not limited to, donations, volunteers, membership drives, surveys, polling services, and any other similar type of avenues with which contacts may further the goals of a business, individual, or organization. While much of the present disclosure may describe sales leads as an example, other leads described above are equally applicable to the systems and methods described herein.

Many sales-based systems are directed solely to lead generation where there is no previous relationship between the lead and sales person (e.g., “cold-calling”). Such potential targets are referred to herein as “suspects.” Lead processing as used herein instead focuses on leads as defined—where there is an existing relationship, awareness, and/or contact. Various existing programs that address lead generation and/or lead processing tend to be directed to a single task or a small category of tasks that are not related. For example, programs designed for sales teams are generally much different than programs for sales managers.

Most programs that are designed for sales teams allow them to track information used to contact a potential lead and are often flexible with respect to the ability to accommodate differences between leads. Examples include systems commonly known as ACT!® and Goldmine®. One drawback regarding these systems is that the information is generally not centralized, thus making them less useful as a sales management tool. On the other hand, most programs that are designed for sales managers focus more on data management, allowing the sales managers to see a big picture of sales information. Examples include SalesForce.com® and SAP®. These systems are centralized and very flexible, but the degree of flexibility makes the tools less useful for the sales team.

Each of the above systems generally rely on much more information for further development of prospect leads (also referred to as “prospects”) than would be possible with low-quality or suspect leads (also referred to as “potential leads”) that lack such additional information. As used herein, prospect leads are those that have attained a higher level of interest, association, and/or desire for products, services, or contact with the company or organization. Suspect leads, however, are much lower quality contacts, but contacts nonetheless have the potential to be prospects. For example, a suspect lead may be an alumni of a university, wherein the university desires to raise funds for a building campaign, and the may have donated to the university in the past and/or expressed a desire to have a university building named in their honor.

In sales, low-quality leads or suspect leads are not generally qualified or developed enough to work well with programs designed for either sales teams or sales managers. The problem with leads that are suspects as opposed to prospects is that the process of developing suspects is very different than the process of developing prospects. With prospects, the process (e.g., campaign) needs to be flexible in order to handle the randomness of each individual lead. Flexibility allows for providing a prospect with any type of information or resource that will help to complete a sale or formalize a desired response (e.g., donation, agreement to volunteer, response to a polling questionnaire, etc.). With suspects, while the design of any given process needs to be flexible, applying the process to the individual suspects is very cut and dry; meaning, for example, systematic contact attempts better used on suspects could elevate a suspect to a prospect. Sales and lead generation systems in use today generally do not have the concept of a multi-step, multi-faceted (e.g., systematic) campaign incorporated therein. Likewise, professional salespeople who generally work with prospects tend to be creative people who aren't suited for systematic processes needed for suspects. The table below shows a traditional model of current marketing technology, showing the three common ways to deliver information.

| | | | | | Purchase |
|---|---|---|---|---|---|
| | | | | | Proba- |
| | Approach | Example | Effect | Category | bility |
| 1 | Mass | such as | Shotgun ap- | One | Extremely |
| | Marketing | adver- | proach to | to Many | Low |
| | | tisements | the market - | | |
| | | | one piece to | | |
| | | | many readers | | |
| 2 | Direct | such as | Targeted ap- | Many | Very Low |
| | Marketing, | direct mail | proach to | to Many | |
| | | | the market - | | |
| | | | different | | |
| | | | pieces to | | |
| | | | different | | |
| | | | specific | | |
| | | | target | | |
| | | | markets | | |
| 3 | Direct | Individual | One on one | One | Medium |
| | Selling/ | Salespeople | approach to | to One | to High |
| | Contacting | and/or Repre- | specific | | |
| | | sentatives | target | | |

In the above model, leads generally get categorized as either “hot” (e.g., a prospect) or “cold” (e.g., no interest from lead), with no concept of a “warm” lead (e.g., lead may be interested). The process for handling the hot leads by direct selling is expensive, and therefore anything other than a hot lead generally falls into the cold category simply by default. Suspects don't fit the above model as they would reside somewhere from very low to medium on purchase probability. As a result, suspects are not generally a target for traditional sales campaigns and get treated like mailing list quality leads (e.g., low-value), often having sent periodic newsletters, publications, etc.

There are no known systems that incorporate lead processing systems into other venues such as charity and political donations and/or requests for volunteers, membership drives, survey and polling services. For example, current political groups may possess lists of contacts derived from records of previous donations, voting records, and the like, wherein the lead may contacted in a desire to donate to a campaign, volunteer for the campaign, or some other desired action. Similar unmet needs likewise exist for charities, booster programs, volunteer groups, membership organizations, job seekers, as an add-on for SaaS applications, and any other person or entity that desires a response from one or more leads.

In consequence, the art continues to seek improvements in developing systems and methods for improving communication channels to potential leads (e.g., suspects) in high volume, in an individual (e.g., one-to-one) manner, and at a low cost.

### SUMMARY

The present disclosure relates to systems and methods for automated lead processing.

In one aspect, the disclosure relates to a computer-implemented automated lead processing system for lead development, the system comprising: a lead set comprising lead data for one or more potential leads; and a table-driven customizable campaign interface for selection of a sequence of lead development steps applicable to said one or more potential leads, to initiate automated processing of said lead data in said lead set for said one or more potential leads, and to generate a monitoring record in a database of the system of said sequence of lead development steps, wherein the system is adapted on occurrence of at least one predefined trigger event to signal at least one action to be taken relating to the sequence of lead development steps, and wherein the system is adapted to display a status determination on said interface for said one or more potential leads.

In another aspect, the disclosure relates to a computer-implemented method for automated lead processing, the method comprising: inputting on said computer a lead set comprising lead data for one or more potential leads; generating on an interface of said computer a table-driven customizable campaign on the interface related to said lead set; and selecting on said interface a sequence of lead development steps applicable to said one or more potential leads, wherein said computer is adapted on occurrence of at least one predefined trigger event to signal at least one action to be taken relating to the sequence of lead development steps, and wherein the computer is adapted to display a status determination on said interface for said one or more potential leads.

Other aspects, features and embodiments of the disclosure will be more fully apparent from the ensuing disclosure and appended claims.

### BRIEF DESCRIPTION OF THE DRAWINGS

FIG. 1 is a schematic representation of the automated lead processing methodology according to one embodiment of the present disclosure.

FIG. 2 is a screen shot of a contact information text window according to one embodiment of the present disclosure.

FIG. 3 is a screen shot of a contact options according to one embodiment of the present disclosure.

FIG. 3 is a screen shot of a contact options according to a further embodiment of the present disclosure.

FIG. 5 is a screen shot of software according to one embodiment of the present disclosure.

FIG. 6 is a screen shot of software according to one embodiment of the present disclosure.

FIG. 7 is a screen shot of software according to one embodiment of the present disclosure.

FIG. 8 is a screen shot of software according to one embodiment of the present disclosure.

FIG. 9 is a screen shot of software according to one embodiment of the present disclosure.

FIG. 10 is a screen shot of software according to one embodiment of the present disclosure.

FIG. 11 is a screen shot of software according to one embodiment of the present disclosure.

FIG. 12 is a screen shot of software according to one embodiment of the present disclosure.

FIG. 13 is a screen shot of software according to one embodiment of the present disclosure.

FIG. 14 is a screen shot of software according to one embodiment of the present disclosure.

FIG. 15 is a screen shot of software according to one embodiment of the present disclosure.

FIG. 16 is a screen shot of software according to one embodiment of the present disclosure.

FIG. 17 is a screen shot of software according to one embodiment of the present disclosure.

FIG. 18 is a screen shot of software according to one embodiment of the present disclosure.

FIG. 19 is a screen shot of software according to one embodiment of the present disclosure.

FIG. 20 is a screen shot of software according to one embodiment of the present disclosure.

FIG. 21 is a screen shot of software according to one embodiment of the present disclosure.

FIG. 22 is a screen shot of software according to one embodiment of the present disclosure.

### DETAILED DESCRIPTION

The present disclosure relates to systems and methods for automated lead processing.

Unless otherwise defined, terms used herein should be construed to have the same meaning as commonly understood by one of ordinary skill in the art to which this disclosure belongs. It will be further understood that terms used herein should be interpreted as having a meaning that is consistent with their meaning in the context of this specification and the relevant art. Further, the use of any term in this disclosure in one tense or context shall not be limited to only the tense or context of the term as used.

Unless the absence of one or more elements is specifically recited, the terms “comprising,” “including,” and “having” as used herein should be interpreted as open-ended terms that do not preclude the presence of one or more elements.

In one embodiment, a system and method is provided to allow one-to-one lead promotion (e.g., promotion from suspect to prospect) to a high volume of specific potential leads by allowing for a pre-defined (e.g., customizable) campaign to be created for that potential prospect set, determining all the possible outcomes of the execution of that campaign and then automating that process. As used herein, “campaign” generally means an implementation of a contact strategy for a product, service, market segment (niche), or other service (e.g., volunteering, donations, polling, etc.) to achieve specified objectives. Campaigns can be based and focused on a geographical area, a consumer base, or any other variable.

In one embodiment, suspects all get handled individually, in an automated fashion (e.g., in a sequence), and can then be positively identified either: (1) as prospects, at which point the direct contact with the prospect may be implemented or finalized; or (2) as not currently qualified, in which case other less-expensive marketing techniques can be employed. When a lead reaches prospect status, the automated lead process system of the present disclosure may optionally initiate direct contact with the prospect by any number of means described herein to elicit a desired response (e.g., purchase of goods or services, donation, acquiescence to volunteer, etc.) as desired.

In one embodiment, lead processes allow for automation under an infinite number of specific definitions and variables which account for all possible outcomes of interactions between the lead generating company/organization and the lead, wherein such definitions and variables may be pre-determined or determined “on the fly” (e.g., during the campaign) to customize the campaign. The campaign is one-on-one (e.g., direct contact with an individual target lead), but is highly automated in a way that current sales/contact tools don't allow. By limiting the flexibility through automating every step in the campaign and leaving a finite set of possible outcomes (each of which can also be automated), the system is more adept at handling such routine processes than existing sales/contact automation processes.

In one embodiment, the first step involves defining a campaign for following up on a particular lead set. The campaign consists of a variety of possible steps and a variety of parameters to define each step. Some examples include, but are not limited to, personal phone calls, personal letters, personal faxes, personal emails, and a personally delivered item. Additional examples may generally include any number of steps personalized for that particular lead, including, but not limited to, an email, a call, a message, a voicemail, a letter, a facsimile, a notification to client, a sending of information, an addition of said one or more potential leads to a mailing list, a text message, and a referral initiation.

As used herein, “notification to client” generally means notifying the client with whom the program is being instituted, wherein the client may include a company (optionally including sales person(s), sales team, and/or sales manager(s)), organization (charitable group, boosters club, membership group), political campaign, or any other person or entity desiring to make contact with the lead to elicit a desired response. This generally occurs when the suspect (e.g., lead with a status that is generally not qualified or developed, meaning the lead and the client likely have little or no previous connection or correspondence) advances to a prospect (for any number of reasons, including, but not limited to, the lead expresses in interest in making a purchase/donation/desire to volunteer, the lead expresses a desire for more information, or the lead expresses a willingness to be contacted, etc.). As used herein, “a referral initiation” generally means when a lead identifies another potential lead (e.g., a referral) that initiates a new potential lead entered into the system. As used herein, a “referral communication” is information provided from one lead about another potential lead.

In one embodiment, the automated lead process generally has three components: (1) the campaign, (2) the lead set, and (3) the execution. In a campaign, each step is executed based on a certain pre-defined trigger event. A “trigger event” may comprise any of an elapse of time, an inquiry from a client, a communication from said one or more potential leads, a news event, a referral communication, or other event which provides some reason to initiate communication with the lead. The trigger event may be pre-defined for each campaign, wherein the campaign may include a number of trigger events depending upon the client's focus. In many cases, the trigger event may include an elapse of time with no response from the lead. An inquiry from the client (e.g., the company/organization desiring the contact with the lead) may be a trigger event to execute a lead development step (generally in the predetermined sequence according to the present disclosure). In one example, the inquiry from the client may include additional information provided from the client about the lead, wherein follow-up with the lead is desired. A “news event” may signal information related to the lead, wherein execution of the lead development step is initiated. For example, a news event may be news related to an initial public offering (“IPO”) of the lead's company covered in a news article, wherein a communication commenting on the IPO is made to the lead. The system according to one embodiment provides an option for initiating a search of information related to the lead (e.g., news, clinical trial data, drug pipeline data, or any other published information). The system may provide an automatic search function tied into the internet or other source of information to periodically or constantly update information related to a particular lead. As used herein, “news” refers to any public or private communication of information generally regarding current events, whether published or available through a paid site containing such information.

In various embodiments, each lead gets its own instance (e.g., sequence of lead development steps) of the campaign and each instance can be executed separately or halted independently of any other instance of the campaign. In various embodiments, the instances may share the traits of the same campaign such as the number of steps, order and type of steps, time between steps and any other campaign specific traits that may be defined for that campaign.

In various embodiments, the “lead set” is all the information that is known or derived about each lead. In addition to the information that is provided by the lead itself, the automated lead processing system in one embodiment also provides for additional details such as, but not limited to, pronunciation of the name, gender of the lead, associated salesperson/representative information such as territory, phone number, email address, and other information that may be required. Some information in the lead set may not be available at the beginning of a campaign instance for a given lead. In one embodiment, information about a lead including, but not limited to, phone number, email address and the like may be missing and the automated lead process may be responsible for acquiring or attempting to acquire the additional details. In instances where additional information is needed, updating of lead data may be accomplished by any number of methods, including, but not limited to, contacting a sales person/manager or organization representative associated with the lead, instituting a search of information for that lead, or contacting the lead with what information is available to gain additional information. For example, with regard to a school booster, an initial contact may be made with a lead having one or more children enrolled in the school to simply update and/or verify information. Such information can then be input into the system for further institution of the campaign of the school booster in raising funds for the school.

In one embodiment, an email address may be missing for one lead, but the lead may be part of the same company as another lead (wherein a reconciling of lead data is accomplished to link the two leads at the same company) for whom the system has an email address. An analysis is made of the name of the lead having the email address with the company name, and such methodology is duplicated to the lead without the email address to attempt to reconcile the email address. An interface automatically recognizes the missing email, the related lead from the same company, the methodology of the lead's email address that is available, and then duplicates that methodology to the lead lacking the email address in an attempt to derive the correct address. The email may retain the status of “unconfirmed” until a confirmatory email is sent and verification is provided (e.g., return email from lead and/or lack of bounce-back email). A lead development step of an email is initiated and sent to the lead with the derived email address. Any bounce-back of the email will signal a failed email. For example, John Doe at Acme Co. has an email of jdoe@acme.com. Another lead at the company has a name of John Smith, but no email is available. The system detects the lack of email, generally prior to the sequence of lead development step of an email to the lead, and then goes through the process of deriving John Smith's email address as jsmith@acme.com. Once the email is confirmed, the status of John Smith's email changes from unconfirmed to validated.

In various embodiments, “execution” occurs when an instance of the Campaign is created for each lead in the lead set. In one embodiment, a user of a software-based tool incorporating an automated lead processing system rigidly executes the various steps in the campaign with little room for creativity. In one embodiment, the current campaign step is automated for each lead and all possible results are displayed as single-click options. Therefore, a user of an automated lead process can generally handle up to 20 times as many leads per hour as compared with non-automated systems.

As used herein, the disclosure according to various embodiments may be called “automated lead processing system” or “ALP,” referring either to the system, method, and/or software program described herein.

In various embodiments, each campaign interacts with the lead set at that particular moment in time. Each lead may be handled independently with the benefits of scale being based on the advanced preparation (e.g., customized campaign with predefined trigger events) for the sum total of the campaign. For example, when following up 1000 leads from a trade show, lead development of 1000 records individually will produce good results by way of direct sales/contact calls, but a sales person or organization representative may have to perform 1000 steps all independently from each other which is very time consuming and expensive. Each step may be presented separately and differently resulting in varied results. According to one embodiment of the present disclosure, the automated lead processing system would not handle the 1000 records any differently since the campaign simply comprises 1000 repetitive lead development steps. As a result, scaling up or down the lead set is easily performed by the ALP. In various embodiments, ALP can be used equally well to handle website registrations, whether once a week or a 1000 or more at a time. For instance, if a lead is reviewing a website following a trade show or as an effort to search for information about a company, product, or organization, a registration step would allow the site to collect such data and initiate an instance of contact within a campaign similar to other leads. ALP scales the handling of leads by incorporating more or fewer users of the system. ALP users handle the individual records placed on their computer screens by the program or system (e.g., campaign interface). Users of the system become effective by executing the same sequence of lead development steps multiple times and becoming good at using the system. The system does not need large quantities of users, which makes it more cost effective than traditional systems.

One advantage to the present system and method is that all potential leads get vetted. The alternative of lead scoring is merely an educated guess at which leads are worth pursuing. Another advantage is that companies get a reliable, repeatable methodology for managing leads from trade shows or other sources that eliminates the variations between salespeople and/or representatives. Another advantage is that all leads have a shelf life, where the sooner they can be qualified and started moving toward a sale and/or desired response, the most likely a sale and/or desired response will be completed—ALP acts quickly with all leads input into the system. As used herein, a “qualified” lead or “qualifying” a lead refers to elevating the potential lead into a prospective lead (also referred to as “elevated from suspect to prospect”), wherein a traditional sales/contact method may be employed to complete the sale/contact.

In one embodiment, Person A may act on behalf of Person B (or any other company, organization, etc.) for the purpose of qualifying a set of low-priority leads. Emails, letters, faxes and other forms of communication (generally personalized to the lead) are sent to the lead as though from Person B in a manner proscribed by Person B, but without actually involving Person B until the low-priority lead is contacted and is determined to be a higher-priority lead. For example, an email sent by Person A on behalf of Person B will have Person B's signature line, default return email address, indentifying information, and signature. A campaign is generated on an interface of a computer, including information about the various salespeople, representatives, company, and/or organization (or other pertinent facts about the reasons for contacting the lead) and additional background information (e.g., sales person territory, organization goals in applying money donated, etc.). With regard to sales and representative territories that might be split within the client for handling purposes, each territory can be delineated by, for example, different area codes, zip codes, states, cities, voting or school district, SIC codes or some other differentiator. A default contact may be used when no territory fits based on the parameters of the lead. The client (company, organization, etc.) also provides contact information about each of the salespeople or representatives that would follow-up on the prospect leads. In some cases, an ALP system and users may handle the full cradle to grave contact elevation (from suspect to prospect), and completion of correspondence with the lead to elicit a desired response (e.g., sale, donation, volunteer, etc.) rather than shifting the lead to a sales person or representative once the lead is elevated.

In various embodiments, campaigns may be set up to deal with a variety of lead generating events such as trade shows, website registrations, news articles, referrals, networking events, annual alumni reunions, political campaign events, etc. In various embodiments, the campaign starts with a listing of each step in the instance of the campaign to correspond with the lead to determine if there is interest from the lead. Campaign information may be stored in a table or set of tables as an abstracted definition of the campaign, and not necessarily a strictly programmed definition. Each instance of the campaign for each lead will, for each step, check back to the table so that if any changes are made, each instance will react in real-time. As such, no programming is required to define or run the campaign—hence it is “table-driven.” In various embodiments, campaigns generally have a name and a unique identifier that may be accessible only to those with the proper permissions. Each campaign generally may include a start date and end date. Optionally associated with each campaign may be a “referral campaign” which is created when the lead-following company/user enters a lead with whom they have been told to connect. For example, during the course of pursing a campaign aimed at Lead A, Lead A indicates that Lead B would be a better person to pursue (e.g., referral).

In various embodiments, each campaign may have campaign-wide parameters associated therewith, such as a request to have the ALP attempt to find phone numbers, addresses, email addresses, or any other lead data that might be desired. In addition, there can be operational parameters associated with the campaign such as how to handle bad email addresses: should a bad email address end a campaign or not?

In various embodiments, each campaign may contain three defined steps: (1) “notify sales/representative” of company/organization to let them know that ALP is initiated so, for example, they don't duplicate efforts on the same lead; (2) “contact” the lead (e.g., communication outreach); and (3) “send information” to the lead. The communication outreach may include any number of calls, messages, emails, text messages, letters, faxes, voicemails, twitter tweets, Facebook® messages, other electronic mail, visits in person, and any other kind of communication or outreach. The steps can vary and be in any order and frequency. All steps may have a “step type value,” a “step name,” a “wait value” indicating the period of time to wait to let the communication outreach work (e.g., elicit a response after a defined period of time) before going to the next step and a “note value” that gets stored to indicate to reviewers what the particular step of the ALP program is currently involved.

The “notify sales/representative” step is generally the very first step of the campaign. An ALP system will use that step to notify the salesperson or representative that a campaign instance is going to begin shortly targeting a lead that is named in the email. In one embodiment, the salesperson can abort that instance at anytime simply by replying to the notification (e.g., email)—no other action is needed. The “notify sales” step can be any kind of step, and will need the appropriate additional fields. When the “notify sales” step is accomplished by email, it generally will include a subject, body, template name and send time, for example. In one embodiment, the “contact” step involves making contact with the lead, and generally includes a script that the ALP user will read on those occasions where the ALP user actually gets in touch over the phone or via text message with the lead. In one embodiment, the “send info” step is a predefined response to the lead's request to receive more information before talking with the salesperson/representative associated with that lead. Typically, this may include an email step that needs a subject, body template, send time and attachments that constitute the information that has been requested or is desired of the client to be sent to the lead upon such trigger.

In various embodiments, call steps require that a phone call is made on behalf of the appropriate salesperson/representative. This can be accomplished using individual phone numbers, or over a centralized system, or over VoIP, or the like. Calls may be initiated directly through the system, and may be with the CallerID information blocked from the recipient, either manually or automatically as set up during the generation of the campaign. Since not all calls will be completed, calls can either request that a message be left or not. For those that get through to voice mail, a script will generally be provided (full automation according to the present disclosure). A call script can either be read by the ALP user who placed the call, or can be delivered electronically. In one embodiment, an electronically stored message may be created during the campaign creation once a voicemail step is created, wherein an email may be sent to all the salespeople/representatives with the script and a link. When the salespeople/representatives click on the link, their phone will ring and they will be asked to read the voicemail script over the phone, wherein their voice is recorded for playback. In this example, once the ALP user gets to the point where the voice message is to be left, instead of reading the voicemail script themselves, they press a button and the voice message from the appropriate salesperson/representative is left on the lead's voicemail system. Such a voicemail or message may also be scripted for the salespeople/representatives. In one embodiment, all correspondence including letters, emails (or other electronic correspondence) and voice messages may be designed to appear to the lead as coming directly from the salesperson/representative. As such, the presence of an ALP will not be noticeable to the lead.

The email step may include a subject, contents, template file (to allow for customized headers, advertisements, etc.), a send time (to allow for delayed sending to avoid sending overnight or too late in the afternoon), and one or more attachments if desired. Letter and facsimile steps will also generally include additional information in the form of the body of the document as a template if desired.

In various embodiments, each step in ALP is a one-to-one communication capable of being reviewed by a human ALP user, wherein not all the information needs to be exclusively determined in advance. Instead, the documents can be subject to an intelligent process—utilizing human review for emails or letters if desired to increase uniqueness of each item if desired. For example, gender determination can be done on the fly. In one embodiment, the campaign template may read, “he/she suggested I call . . . ” and the ALP user triggered to edit that to “he” or “she” as appropriate. This is useful in situations where computers have difficulty with handling such tasks as determining gender, but allows the computer program to initiate a trigger to the user to make that determination and correct the entry where appropriate.

In various embodiments, other outbound forms may also have parameters that trigger a requirement for certain parameters (e.g., information fields) to be completed/corrected, where such parameters may generally be specified in the definition of the campaign at the time of creation. Even when a campaign is in use, however, it may still be modified “on the fly.” In almost all cases, the subject, body and note entry pieces of the various forms of communication may include variables that allow customization for each individual lead. Any data item from the lead may be used (e.g., first name, company name, etc.) as well as some system items (name of the ALP caller, appropriate salesperson/representative's name, address, email, etc.) and some general purpose items that can be user defined on a campaign-by-campaign basis. For example, a campaign may be set up to follow up news items. In that case, although the steps in the campaign would always be the same, the news item might be different for each lead (e.g., the lead raised money or built a new factory).

The table below is one example of the information computed for lead data, generally allowing for user input on a campaign-by-campaign basis.

| Nameprefix | FirstName | LastName | Salutation | Pronounced |
|---|---|---|---|---|
| Gender | RoleTitle | CompanyName | Addr1 | Addr2 |
| City | State | Zip | PhoneNumber | PhoneLocal |
| Extension | FAXNumber | FaxLocal | CellNumber | CellLocal |
| eMail | Website | AsstName | AssteMail | AsstPhone |
| AsstPhoneLocal | AsstExt | Source | Referrer | LastTouched |
| DateCreated | TimeZoneOffSet | DoNotContact | RemoveFromMailList | |
| AssignedTo | User1 | User2 | User3 | User4 |

In various embodiments, the “execution” phase of the process occurs when the lead set is merged with the actual campaign steps. At this point, the ALP user is representing the client (e.g., company, organization, or the like), wherein a unique salesperson/representative with each unique lead works on behalf of the salesperson/representative or as the salesperson/representative's proxy to optionally connect the lead to the salesperson/representative or complete the desired result by the ALP user. The various results that can be expected from each type of campaign step may be categorized into a few different results and generally turned into as few inputs from the user (e.g., mouse-clicks) as possible. When the parameters are predefined, and once the ALP user starts the campaign, an ALP system can generally initiate most or all follow up actions automatically, far faster than an individual human salesperson/representative. When the ALP user indicates the resulting event, a notes record is automatically created generally noting the date, time, campaign name, user name and step and then whatever else the user might be expected to enter (as often initiated by the campaign setup as directed by the client sales company).

For example, the notes record may provide information about a political campaign drive for donations that results in potential leads for volunteers instead. This type of information is captured, saved, and processed as referral lead data for a department of the campaign directed to organizing volunteers rather than soliciting donations. The same ALP program may also shift campaigns and handle contacting each referral lead for interest in volunteering. Such contact and campaign may all be done by the same ALP user for the same client (e.g., political campaign), thereby flexibly accommodating what might be a potential lead in a different area (volunteering) than that which was originally targeted (donating).

In various embodiments, if the lead development step is a “call” step, the ALP user clicks the phone number desired and clicks dial (or simply clicks the phone number and the system automatically dials the number, accounting for the correct area code and country code). The ALP places the call and displays the script to be read in the event that the ALP user actually gets through to the intended lead. All the variable fields defined in the campaign are replaced with the appropriate detail fields for this particular record. Even as the phone is ringing, the ALP user is preparing for the conversation. Calls generally have a finite number of outcomes, each of which is automated by the ALP, including, but not limited to, contact, voicemail with message, voicemail with no message, gone, out of town (prompting an entry of a return date, which will initiate the sequence of lead development steps in the next order), ring—no answer, and line busy. If the call does not get through to the targeted lead, the ALP user can react based on the situation. There are some situations that don't lend themselves to leaving messages or voice mail and so these can be handled separately. If the call fails because: (1) the line is busy, the user may press the Line Busy button and the call may be rescheduled for instance, 5 minutes from the time the call was initiated on the theory that the target is there, but is on the phone; (2) the line rings, but there is no answer, the user may press the RNA (“Ring No Answer”) button and the call may be rescheduled for instance, 2 hours from the time the call was initiated on the theory that the target is not there; (3) the lead no longer works for that company, the user may press the Gone button and the campaign is ended or a trigger event is initiated to search for the lead in a new position with a new company/organization; or (4) the lead is out of town, the user may determine when the lead will return and press the OOT (“Out Of Town”) button, wherein the call may rescheduled for instance, one business day after the return.

If the call does not get through to the targeted Lead, and the caller is, instead, directed to voice mail, the caller clicks the appropriate campaign button and then if the campaign step is: (1) Voice Mail, the appropriate Voice Mail script pops up and, at the appropriate time the caller reads the script onto the voice mail system. If the campaign has been set up with VoIP and/or a copy of the salesperson/representative's reading of the script is available, no script will appear and instead a button for the ALP user to press when ready to have the salesperson/representative's voice delivered to the voice mail system; or (2) Voice Mail—no message, the caller is done.

In various embodiments, the system notes the date, the time, the caller, the campaign and any notes associated with this step and automatically schedules the next step for the appropriate time, based on the campaign. Generally, the purpose of every step is to achieve contact and closure with the lead. As such, the most desired result is the contact. With contact between the target lead and ALP user, a call (or other correspondence) has been initiated and the ALP user is actually connected to the intended target lead. With a telephone call to the lead (without a recording from the salesperson/representative), the designated script will be displayed for the ALP caller. Upon completion of the script, and the following discussion, only a few possible outcomes remain which are also automated: (1) Referral—the lead indicates that he is not the right person, but provides information on who the right person might be for the ALP user to contact. This likely ends the campaign for this lead, but creates a new lead record based on the information provided by the contacted lead, thereby associating the new lead with the referral campaign designated for the new campaign. It also sends a Notify Sales email to the appropriate salesperson/representative associated with the new lead, along with a status update for lead whose campaign has ended. (2) Please Call—Sends correspondence (e.g., email) to the appropriate salesperson/representative, along with an attached text file with the contact information of this lead, indicating that an ALP system has contacted this lead and they are, indeed, a prospect. (3) Send Info—Sends the pre-drafted (with or without attachments, links, etc.) Send Info email from the appropriate salesperson/representative with additional information for the lead and also sends an email to the ALP user acting on behalf of the appropriate salesperson/representative, along with an attached text file with the contact information for the lead, indicating that an ALP system has contacted the lead and they are, indeed, a prospect. (4) Mailing List—Ends the campaign for this lead recognizing they are, in fact, at best a suspect (e.g., where a lead indicates that they are not at this time interested). (5) No Interest List—Ends the campaign for this lead recognizing they are not even a suspect (e.g., the lead expresses a desire not to be contacted and/or no interest). (6) Back Burner—A popup window asks how many months and then sends an email to the appropriate salesperson/representative, along with an attached text file with the contact information of this lead, indicating that an ALP system has contacted this lead and they are, indeed, a prospect, but will not be ready for a certain period of time (e.g., where the lead indicates that a later time may be appropriate for making contact regarding the interest of the company/organization).

In various embodiments, emails to the leads may be sent out using the ‘Reply To’ address of the appropriate salesperson/representative so that replies are directed to that salesperson/representative and the template of the selling company (or organization, etc.) so that it appears to the lead as though it came from that salesperson/representative. The system email ‘From Address’ may remain the ALP address so that emails that fail to get delivered (e.g., due to a bad email address) get returned to an ALP system so that the Lead Set can be updated.

Since an email template may be used, the email may be as complicated and ornate as desired with pictures and charts and links and whatever else is desired. Further, HTML can be embedded in the text that is entered from the campaign definition. This allows hyperlinks to be easily incorporated even into the variable text. Emails to the lead can also be customized with the salesperson/representative's signature line. An ALP system will provide for any number lines of identifying information about the salesperson/representative below the signature. Letters created by ALP may also be on a predefined letterhead template. They may be printed in color on white paper on one printer while the envelopes are fed through another in parallel. In this way, the campaign can provide letters that appear to have come from the company in a one-off fashion. Faxes created by ALP may also be on a predefined letterhead template.

In one embodiment, the client may be a political campaign or organization with a desire to elicit donations and/or volunteers. An ALP system is set up on a user's machine with a predefined set of field data provided in advance. The data may be derived from voting records, donations in the past, etc. An ALP user will initiate the campaign for a set of leads (e.g., donors and/or volunteers) by setting the various campaign steps (e.g., first call, followed by email, followed by letter, followed by a second call), trigger events (e.g., wait 2 days after first call to send email, wait 1 day after email to send letter by first class mail, wait 1 week to make 2^{nd} call, and initiate at any time call based on predefined news event), and loading the lead data. Each instance is handled by the ALP user separately, following the same campaign steps and trigger events which were defined in advanced and optionally approved by the client. In one example, with an initial campaign instance of a call to a potential donor lead, the potential donor lead remarks that the bad economy precludes the lead from donating but the lead expresses an interest in volunteering. The campaign instance is immediately shifted upon entry by the ALP user of the change, and such lead is identified as a prospect for volunteering for the campaign. If suitable to the client, the new volunteer prospect lead may also have the ALP software installed on their home computer, with phone and other correspondence lines connected through such software, wherein the lead prospect volunteer may now act as an ALP user remotely from his or her home.

In one embodiment, with the prevalence of ALP users having access to personal data, the system may be configured such that personal information is never revealed to the ALP user. For example, if a call is to be made to a potential lead, the number may not be revealed on the ALP user's screen, instead just a “Call” button which would initiate a call to the ALP user's phone line (if such user was not utilizing VIOP or a similar computer baser program), and the other end of the call would be connected to the lead. The ALP user would never have access to the personal information (e.g., telephone number, address, etc.) of the lead, and the lead's caller-ID for instance, could be set to bring up any desired identifying information (e.g., instead the ALP user's number, the number of the client or no number at all). This same information protection may be utilized for email, facsimile, etc.

In one embodiment, the correspondence from the ALP user and ALP system would account for visually impaired, hearing impaired, and the like, individuals who would need such accommodating correspondence. Such systems may automatically detect TDD/TTY Phone Systems and the like which would also translate letters into Braille, messages comprising text into voice, and similarly accommodating correspondence.

In one embodiment, an ALP system will have individual security features, including password and voice recognition software, to account for specific ALP users and access to the software and systems.

In one embodiment, an ALP system is a web-based application for individuals looking for jobs to follow up on job leads. Such an application would allow people to edit a standard campaign to suit their purposes and include their own resumes and custom contact information, although it may be limited to only one fully functional campaign. It would provide the user with the Caller Screen so that they could do all the follow up themselves. By having a campaign with pre-set follow up schedules, they could be driven to follow up all their contacts in a timely manner.

In one embodiment, a system comprises a SaaS application wherein users are trained to use the entire application, including the follow-up screen generally reserved for use by an ALP. Users can create their own campaigns and do the follow-up. Such a system can be extended from an individual SaaS application working in a stand-alone environment to being an add-on to other applications such as Salesforce.com® or ACT!®.

The advantages and features of the disclosure are further illustrated with reference to the following example, which is not to be construed as in any way limiting the scope of the disclosure but rather as illustrative of one or more embodiments of the disclosure in a specific application thereof.

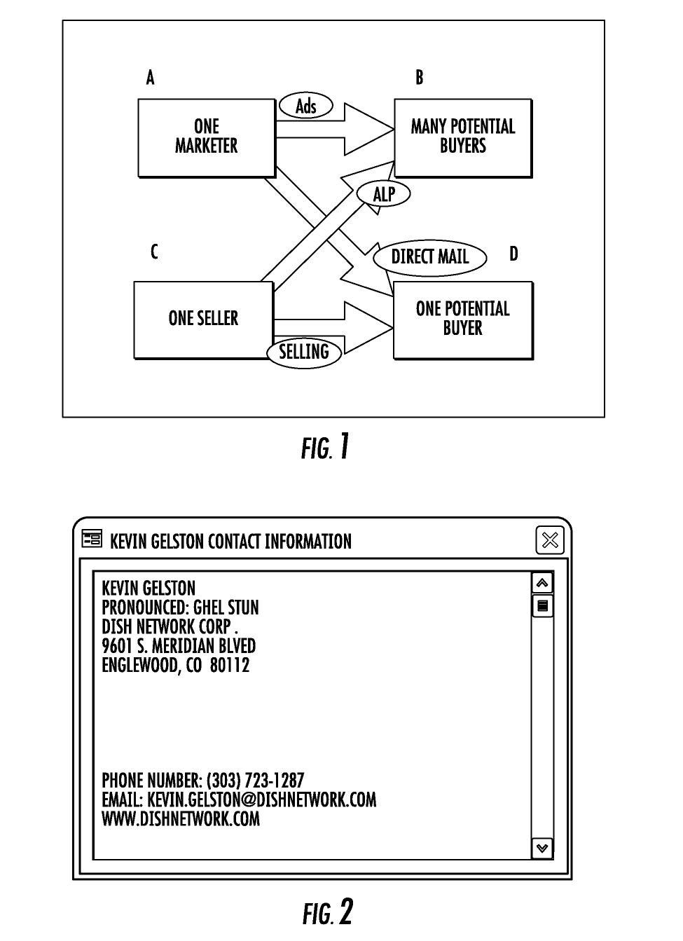

FIG. 1 represents the automated lead processing methodology according to one embodiment of the present disclosure. The one seller servicing many potential buyers is one goal and advantage of the present disclosure over other systems and methods.

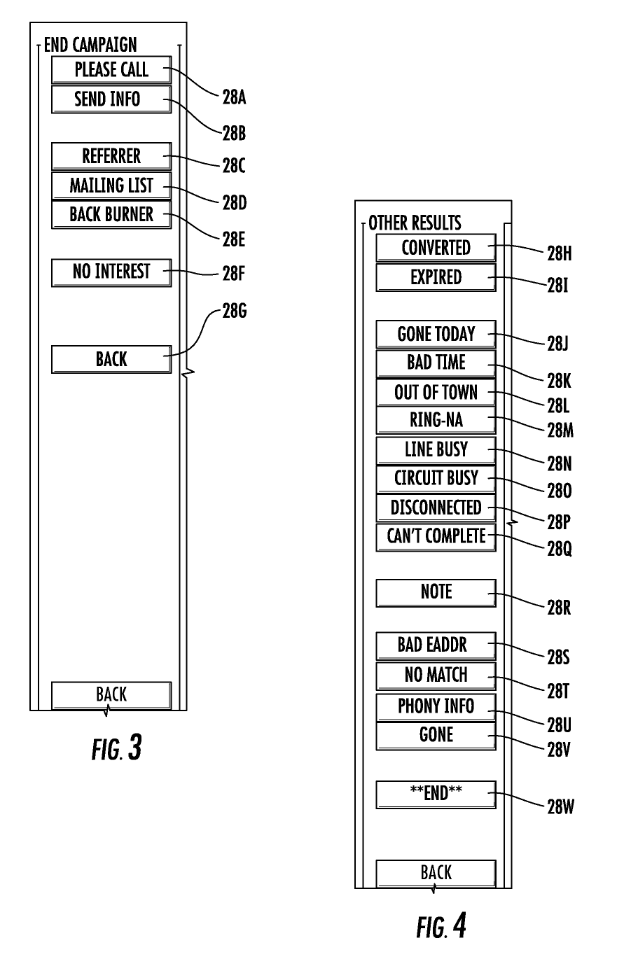

FIG. 2 is a screen shot of a contact information text window according to one embodiment of the present disclosure. The separate text window allows for easy copying of information regarding a prospect. No editing happens in this window so there is no danger of accidentally modifying the underlying information.

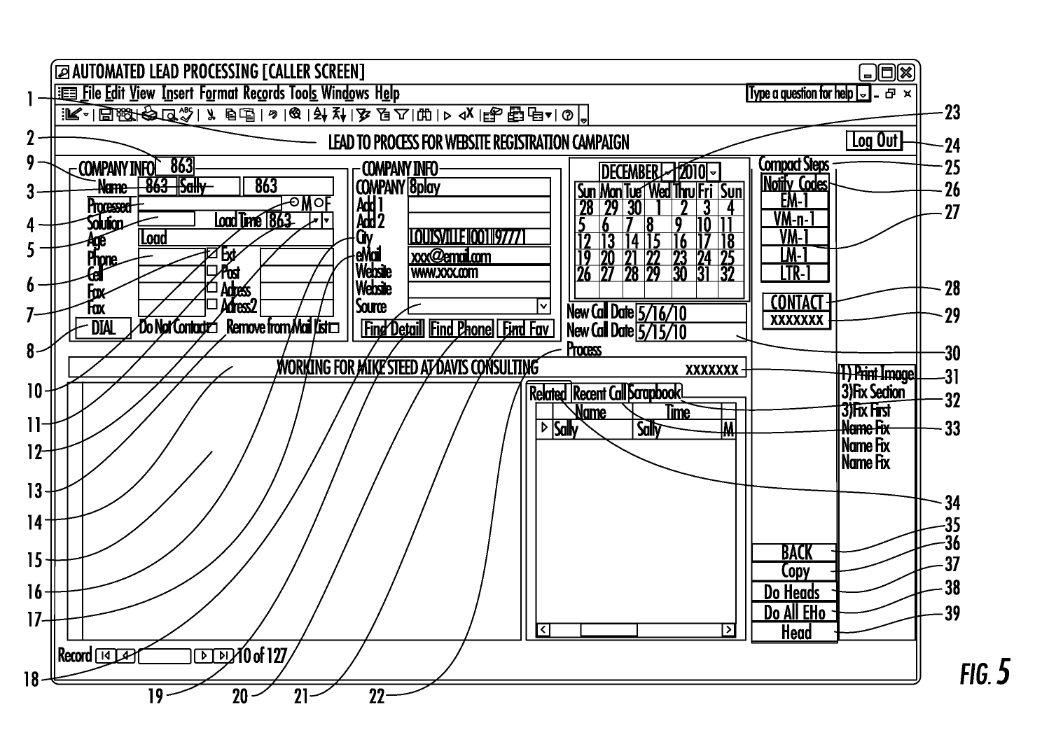

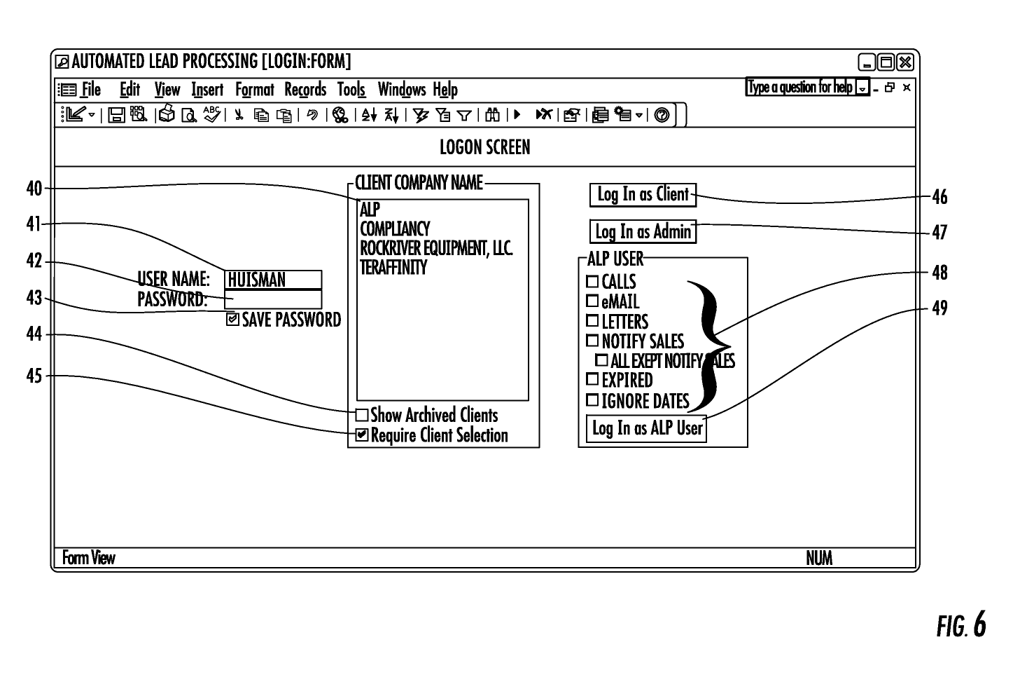

FIG. 3 is a screen shot of a contact options following triggering of the contact button 28 as in FIG. 5. If a prospect wants the client to call, a please call button 28A is pressed and an email is generated to the appropriate client (or sales person) contact to let them know to follow up. If a prospect wants more information prior to getting a call, a send info button 28B is provided to generate an email to the prospect including additional information, while and an additional email is generated to the appropriate client to let them know to follow up. If a contact indicates that they are not the proper person, but notes that someone else might be a prospect, a referrer button 28C allows for notation of that fact and gathers contact information about the prospect for whom contact refers. The referrer button 28C may also initiate the creation of a new related record for the new prospect and an associated new instance of a Referral Campaign associated with a current campaign. A correspondence may be generated to the client (e.g., appropriate salesperson) letting them know that the new prospect is about to be called (a Notify Sales email).

A mailing list button 28D may be provided if the prospect is only marginally interested and wants to be placed on a mailing list, but has no interest in pursuing a sales call for the foreseeable future. This would downgrade the prospect to a suspect to be added to a mailing list. A back burner button 28E is for a prospect who does want to discuss the matter subject to the campaign further, but not at the present time. The system prompts the user to ask for a good time to call and then sends an email to the client (e.g., appropriate salesperson) indicating a good time to make contact. The email also includes the notes from this prospect and/or call. A no interest button 28F is pressed when the prospect has no interest, signaling nothing further to happen. A back button may be provided, for example, if Contact button 28 was pressed by accident to close the pop-up of FIG. 3 and return to the Campaign of FIG. 5. Each of the buttons 28A-28F (except 28G) enters a date-time stamp, campaign name, user name and notation from the campaign.

Additional information may be added, including, for example, the self-indicated buttons 28H-28W of FIG. 4. Once complete, the record may be automatically moved from a current table of leads to a past table.

FIG. 5 is a screen shot of software according to one embodiment of the present disclosure. The campaign identity banner 1 provides identification for which campaign is currently active, which is useful if multiple campaigns are being instituted. The Contact ID 2 is simply a way of keeping records correct. This is an auto-generated sequential number so that if two people in the same company have the same name, they can be handled separately. The Name fields 3 drive the email and letter campaigns. If the 1st field 3 is Dr., the letter will be addressed as Dear Dr. LastName (unless there is a Salutation, in which case that over-rides the Dr. field). If it is Mr., Ms. or anything else, letters and emails are addressed as Dear FirstName. Here “LastName” is an insert for the last name of an individual, and “FirstName” is the insert for the first name of the individual. In various embodiments, a color-coded (e.g., blue-ish) background indicates an auto-parsing field. If the entire name is entered into this field (e.g., Kenneth Smith, PhD.), the name will be parsed into the three name fields appropriately.

A pronunciation field 4 may be provided so that callers will properly address the prospects. This field 4 may be entered as soon as it is discovered. The salutation field 5 is used to indicate the name most often used to address the prospect (e.g., nickname). In the case of Kenneth Smith, PhD, it might be Ken.

Three phone fields 6 may be provided for each prospect. In one embodiment, clicking on any phone field 6 and then clicking the dial button next will dial that number. In one embodiment, a Dial-Local check box 7 may be provided. Depending on the phone system, sometimes “1” and the area code must be dialed—even if calling inside the same area code; sometimes not. If this box is checked, only the 7 digit prefix and number will be used. The Dial button 8 uses the contents of the most recently clicked phone field 6 as a number to call. If that box was not one of the known phone number boxes, a question is raised to make sure that the content is to be dialed. This allows dialing of other phone numbers, even if they are located in a wrong field.

If the Dial button is clicked while the shift key is depressed, the phone number dialed will be preceded by ‘*67’ so that Caller ID is blocked. The name button provides a way to dump all the contact information easily for other applications. The information gets dumped to a separate text window as shown in FIG. 2 from where it can be copied.

Gender buttons 10 may also be provided. It is not always possible to tell the gender from the name or title (e.g., Dr.). When calling, however, it is helpful to know the gender of the prospect, particularly when getting a receptionist so the caller can say is “Is he . . . ” or “Is she available?” In one embodiment, the local time 11 of the prospect may be provided. The hours of calling may be set with the campaign. Sometimes, it is necessary to call prospects early to reach those who spend a lot of time out of the office. In any case, all are related to the local time zone as displayed 11 of the prospect. In one embodiment, names of prospects only appear on the calling list when the local time of the prospect is during the appropriate time period. A buttons 12 may be provided to set the local time for the prospect.

In various embodiments, a prospect has the opportunity to ask to be removed from call lists and mail lists, wherein a check box 13 is provided. This information may be sent back to the contracting client.

If a campaign is instituted on behalf of a sales person (e.g., Mike Steed at Davis Consulting), a banner 14 is provided for indication of the specific salesperson who covers to the territory for the client.

In various embodiments, a notes window 15 is provided. Whenever an action is started, the system automatically enters the date, time, user name, campaign name and information regarding the actuated action. The cursor is placed at the end of the automatically entered information so that the user is ready to enter specific data. New entries may be placed on top of older entries in reverse chronological order. Such information can be edited at any time.

In one embodiment, the city, state, and zip code line may be entered into the address field 16 (e.g., Portland, Oreg. 97223), wherein each component will be parsed into three fields as appropriate since the color-coded field indicates an auto-parsing field. If the email address is in the proper format as entered into the email field 17, there is no website indicated for this prospect, and the email domain is not simply an email domain (e.g., gmail, hotmail, etc.), the website is parsed from the email address and inserted automatically into the website field (not labeled, but just below the email field in FIG. 3).

In one embodiment, a source field 18 indicates from where the lead was received. The source is often related to the campaign (e.g., all the website registration leads came from registrations on the website), however, this field 18 is where the name of a referrer would go for a referral campaign in one embodiment. In various embodiments, a find email button 19 launches a specific query (e.g., web-based) intended to find the email for a prospect. If there is already an email address in the email field 17, it will check the domain associated with the email as well as any domain from the website field (not labeled). It is preferred that at least one or more of an email field 17 and website field (not labeled) be populated. In various embodiments, a find phone button 20 launches a specific query (e.g., web-based) intended to find the phone number for a prospect. Similarly, a find fax (i.e., facsimile number) button 21 launches a specific query (e.g., web-based) intended to find a fax number for a prospect.

The propercase link 22 will perform a propercasing function on the field that was clicked immediately before the link was clicked. Propercasing puts all letters in lower case except for the first letter of each word, while specific items such as PhD are ignored. In various embodiments, a calendar button 23 (each date having a respective button) when clicked enters whatever date is selected into a NextCall field (not labeled) if that field was last selected, unless another field (e.g., Notes field 15) was the most recently selected before clicking the calendar button 23. In that case, the selected date is entered into the notes field where the cursor was and the next date is put in the NextCall date field. This is useful when indicating in the notes field 15 when someone is out of town until a given date and scheduling the next call for the day after the prospect returns.

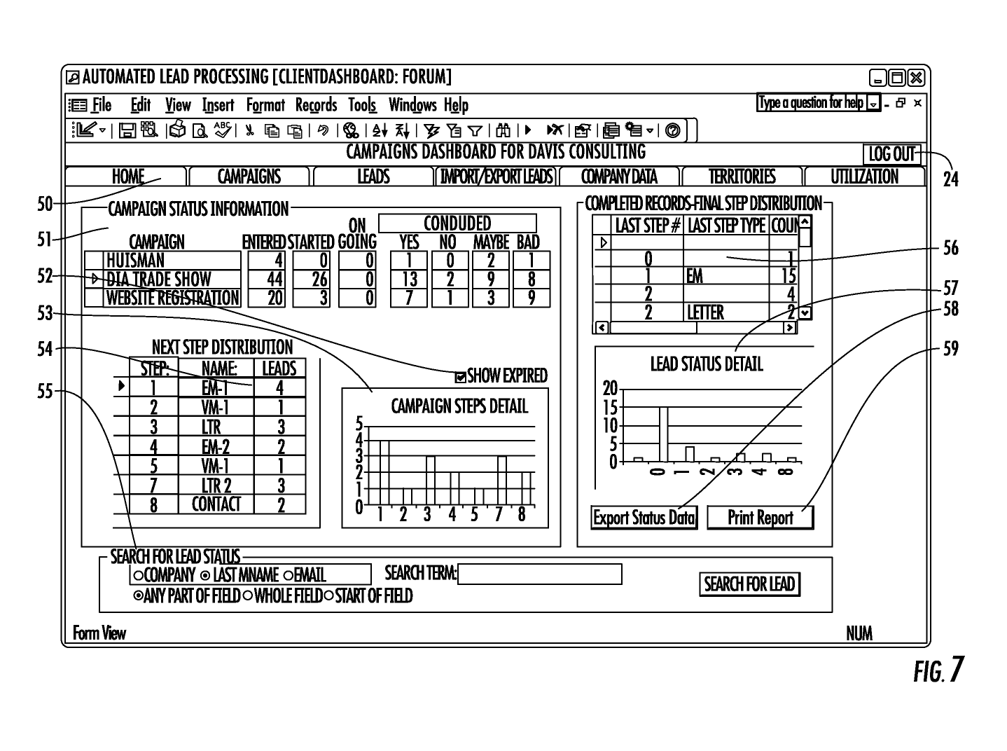

In various embodiments, a log out button 24 closes the current record and goes back to the logon or log-in screen (see FIG. 6). FIG. 5 also reveals campaign steps buttons 25 arranged in the sequential steps selected for the campaign for this prospect. In the present example of FIG. 5, there are five campaign-specific steps 25 in the client's campaign. In one embodiment, the Notify Sales button 26 and step indicates the last completed step has been done. Note that the VM-1 (voice mail) step is preceded by an asterisk (*). This is the indication that this calling step is to be done with the CallerID hidden. If this is the next step, pressing the Dial button will result in a call preceded by “*67” that tells the phone company not to display the caller ID.

In one embodiment, a contact button 28 is pressed when contact is made with the prospect. This brings up another set of option buttons with which to end the campaign that are provided in FIG. 3.

A show history button 30 switches between the records in the Current Lead List and the History Lead list for the current client. This allows the user to review historical records that are not in the Current Lead List. The contact details link 31 pops up a text box with the information about the client (or salesperson) for whom this lead is being worked in case that is needed during the call. The pop up text box may include all essential contact details of the client (or salesperson).

A scoreboard tab 32 displays a table below showing the caller (i.e., user) what their activity has been for the day and, based on their compensation if in sales, shows them also how much money they have earned so far for the day. A recent calls tab 33 displays a table below that shows the thirty (or more) most recently made calls. If there is a reason to go back to a recent record, simply clicking on the name of the recent call takes the user to that record. A related tab 34 displays a table of all the other people that are leads for this same company (e.g., client).

A back button 35 may be included to return to a home or logon screen. A copy button 36 makes a complete copy of a current record as a new record with a new instance of the same campaign associated therewith. This is useful when a user gets an additional lead that needs to be followed in the same way. A Do Notify button 37 will go through all the records that are due on a given day that have “notify client” (or “notify sales”) as the next step. It will perform the action that would have been performed by going to each appropriate record and notifying the client, except it will do them all automatically.

A Do All Emails button 38 will go through all the records due on a given day which include an Email Step as the next step. It will perform the action that would have been performed by going to each appropriate record and pressing the next up EMail button 25, except it will do them all automatically. The Next button 39 takes the user to the next record in their list.

FIG. 6 is a screen shot of the software according to one embodiment of the present disclosure revealing a Logon Screen with a list of clients 40 for whom the user (i.e., caller) is representing. This list of client 40 may include multiple parties if a call center is representing more than one company in lead processing, with a show Archived Clients check box 44 and a Require Client Selection check box 45 wherein selection of a client company records is not necessary when unchecked. The Logon Screen of FIG. 6 may include user name field 41, password field 42, and save password option box 43. The Log In as Client button 46 logs the user in to the screens that the client might normally use. The Log In as Admin button 47 logs the user into the administrative screens. If logging in as an ALP User, the ALP check boxes 48 limit the type of actions that will be available on the Caller Screen. For example, the user can log in only to make calls or to see all actions except Notify Caller steps. The Log In as ALP User button 49 logs the user as an ALP User.

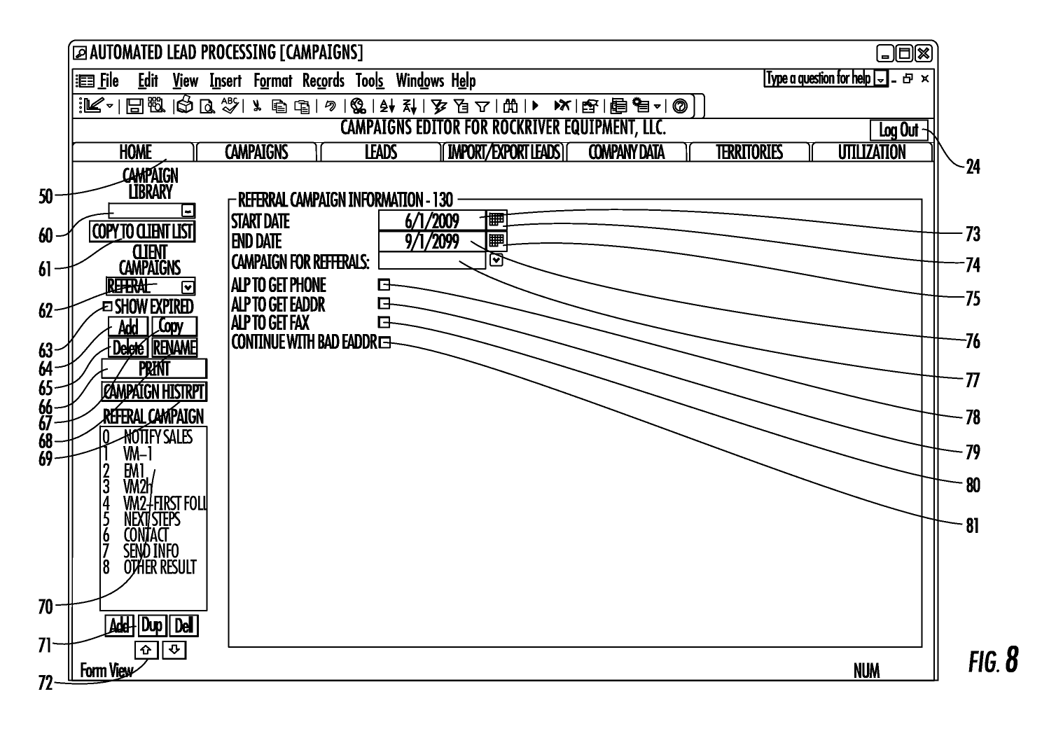

FIG. 7 is a screen shot of the software according to one embodiment of the present disclosure including a row of tabs 50 that allow a user/client to navigate between the seven Client Screens. A Campaign Status Table 51 shows the status of individual campaigns. A Show expired check box 52 allows expired campaigns to be displayed in the Campaign Status Table 51. A Campaign Steps Detail graph 53 provides an indication of the distribution of the steps from the campaign selected in the Campaign Status Table 51. A Next Steps Distribution table 54 provides numeric and descriptive indication of the distribution of the steps from the campaign selected in the Campaign Status Table 51. A Search for Lead Status option boxes and search field 55 allow a user to quickly search for any given lead by a variety of factors. This may be used to enable the quick cancellation of campaigns for specific leads. A Lead Status Detail graph 57 may be included for indication of the final result is for the campaign selected in the Campaign Status Table 51. An Export Status Data button 58 may be included for exporting data in any desired format (e.g., a .CSV file). A Print Report button 59 may be included for printing a report of the Lead Status of the campaign selected in the Campaign Status Table 51.

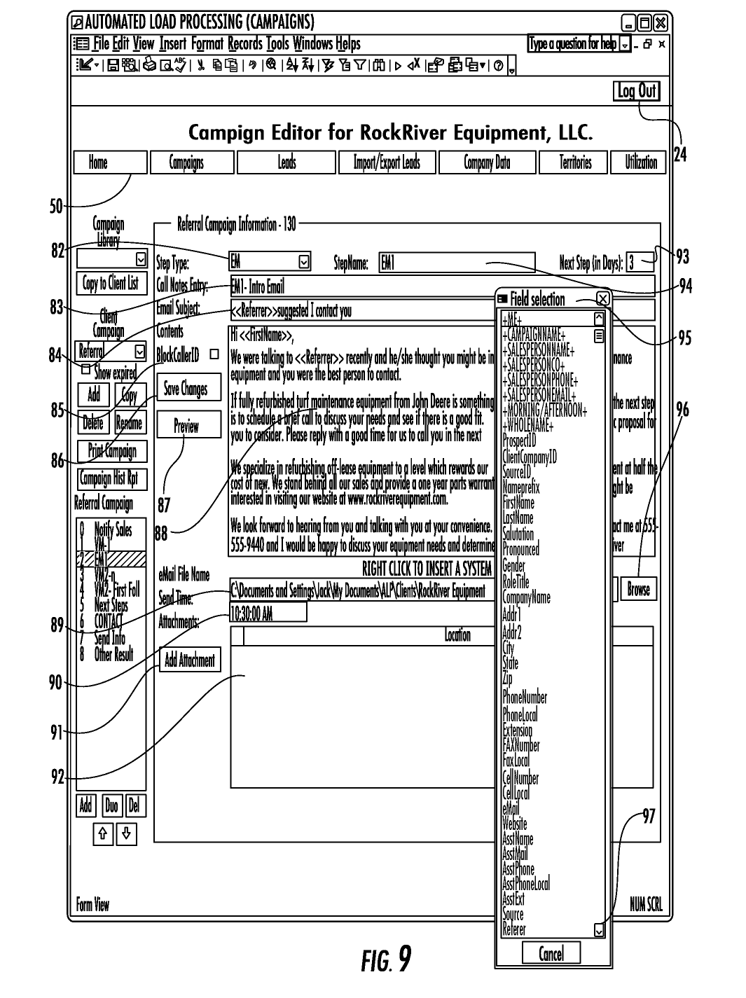

FIG. 8 is a screen shot of the software according to one embodiment of the present disclosure related to a Campaign Editor and includes a plurality of elements. For example, a pre-designed set of campaigns is displayed in a field 60 is stored in a campaign library. The pre-designed set of campaigns 60 may be used to help build other campaigns by allowing for an existing campaign to be accessed and then edited. For example, the campaign library may include templates for event follow up, news items, web registrations, and referrals. A copy to Client List Button 61, when selected, copies the selected campaign (from the predesigned set of campaigns 60) from the campaign library into a client campaign list for the current client. A Client Campaign Listbox 62 shows all the campaigns that have been created for the current client. A Show Expired Checkbox 63, when checked, includes in the Client Campaign Listbox 62 campaigns for the current client that are no longer running as well as current campaigns being performed for the current client. An add button 64 creates a new campaign in the client campaign list displayed in the Client Campaign Listbox 62. A Delete Button 65 removes a selected campaign from the client campaign list displayed in the Client Campaign Listbox 62. A print campaign button 66 creates a printable definition of a selected campaign in the client campaign list displayed in the Client Campaign Listbox 62. A Copy Button Copy Button 67 makes a duplicate of a currently selected campaign in the client campaign list listed in the Client Campaign Listbox 62. A Rename Button 68 allows for the name of the currently selected campaign in the client campaign list presented in the Client Campaign Listbox 62 to be changed.

The Campaign History Report Button 69 causes a campaign history report to be generated for all activity for the currently selected client campaign in the client campaign list. The campaign history report may include two sections: on-going leads and concluded leads. The A Campaign Step List 70 shows all the steps in the currently selected campaign in the client campaign list. Add, duplicate, and Delete Buttons 71 allow for additional steps to be added to the campaign, to be copied from other steps, or to be deleted from the currently selected campaign in the client campaign list. Up Arrow (↑) and Down Arrow (↓) Buttons 72 allow steps in the client campaign list to be reordered.

A Start Date Filed 73 allows the start date to be set for the currently selected campaign in the client campaign list. A First Calendar Button 74 displays a calendar from which to select the start date. An End Date Field 75 enables an expiration date to be set for the currently selected campaign in the client campaign list. A Second Calendar Button 76 displays a calendar from which to select the end date.

A Referrals Campaign Button 77, for most campaigns, enables a related referral campaign needs to be specified when a lead provides a new name or new lead to pursue. A Find Phone Number Field 78 may be checked, which will attempt to find a phone number for one or more prospects in a current campaign. A Get Address Field 79 may be checked to attempt to find an e-mail address for one or more prospects in a current campaign. A Get Fax Field 80 may be checked to attempt to find a fax number for one or more prospects in a current campaign. A Continue With Bad Address Field 81 is checked when the current campaign should continue with other steps when an email address provided for the prospect is rejected.

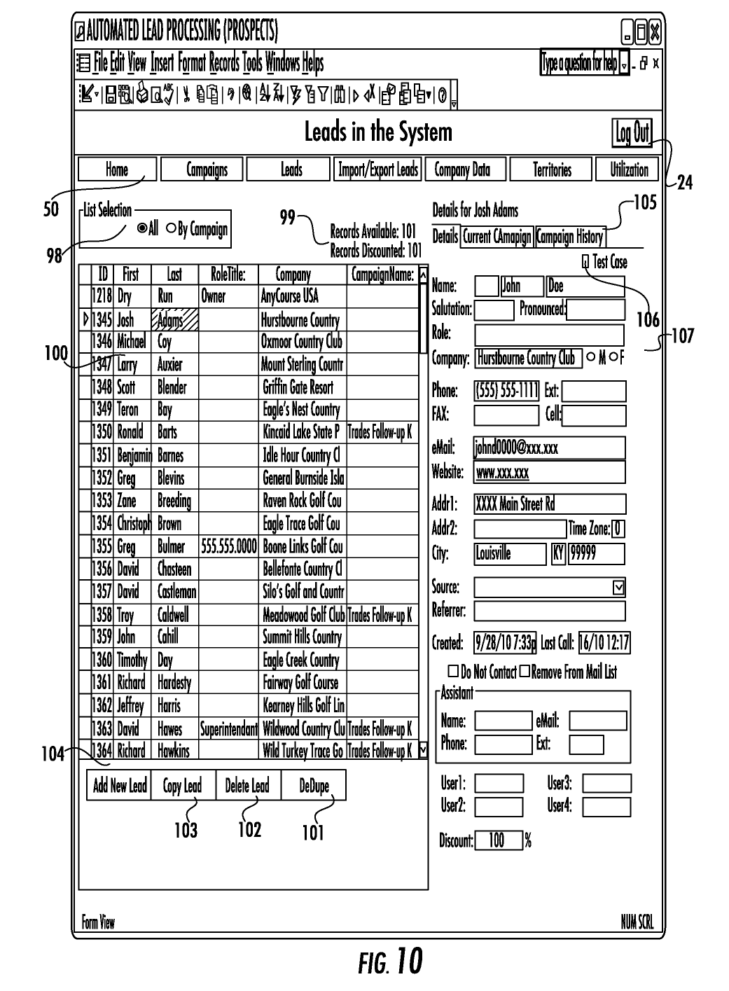

FIG. 9 is a screen shot of the software according to one embodiment of the present disclosure related to a campaign editor and includes a plurality of elements. A Step Type Drop Down Box 82 allows a user to select a step-type for a currently selected step in the current campaign. The step types that may be identified by the Step Type Drop Down Box 82 may include, for example, “VM” for Voice Mail reached or “VM-n” for Voice Mail reached with no message left. The step types may also include “EM” (as shown in the example of FIG. 9) for an email having been sent. The step types may further include “Letter” for a letter having been sent. The step types may include “FAX” for sending of a fax. The step type may include “CONTACT” for contacting the lead later or someone else. The step type may include a “Send Info” step for information having been sent to the contact and, in one embodiment, a notification also having been sent to the associated salesperson. The step type also may include a “Notify Sales” step for indicating that, as an introductory step, a salesperson has been notified that a campaign is being initiated.

A Lead Record Notation 83 indicates a notation that appears with the Lead record when this step is run. A subject line 84 indicates a subject of an e-mail that is used when e-mail is used. A Block Caller ID Field 85 is used when the step includes a telephone call so that when selected, the system will dial “*67” before the contact number is dialed to hide the caller identification (“Caller ID”) information from being displayed at the contact's telephone. A Save Changes Button 86 may be used to provide a way to save any changes while still working on this screen. The save changes button thus may avoid changes being accidentally erased. A preview button generates an example of a script page or an example of an email that may be generated as a result of the selections made and the other information specified on the page or elsewhere in the current campaign.

An E-Mail Body Section 88 includes a body of an email to be sent or a body of a script to be used in a calling step of making a contact. In the case of an email, an Email Template Field 89 enables an email template to be selected for use. A Browse Button 96 enables selection of a selected email template. A Time Field 90 enables the selection of a time at which the email will be sent. In a particular embodiment, emails are not sent prior to the time specified in the time field 90. An Add Attachment Button 91 enables one or more attachments to be appended to an email being created. In a particular embodiment, the add attachment button opens a default directory for the current customer from which one or more attachments may be selected. An Attachment List Field 92 presents names and locations of selected attachments. A Next Step Field 93 indicates how many days are scheduled to pass between execution of the current step and execution of a next step to be performed. A Step Name Field 94 identifies a name for the current step that will be listed in a step list for the campaign for the current client.

For one or more of the fields shown in FIG. 9 and/or other figures, there may be a predetermined list of variables or other values that may be included in those fields. (Such fields may be indicated by highlights or shading.) In this case, an alternative input, such as a right button mouse click in such a field, may invoke a Field Selection List 95. Any item from the field selection list 95 may be selected to be added into the selected field as a variable or other value. One or more Scroll Buttons 97 may enable scrolling within the Field Selection List 95.

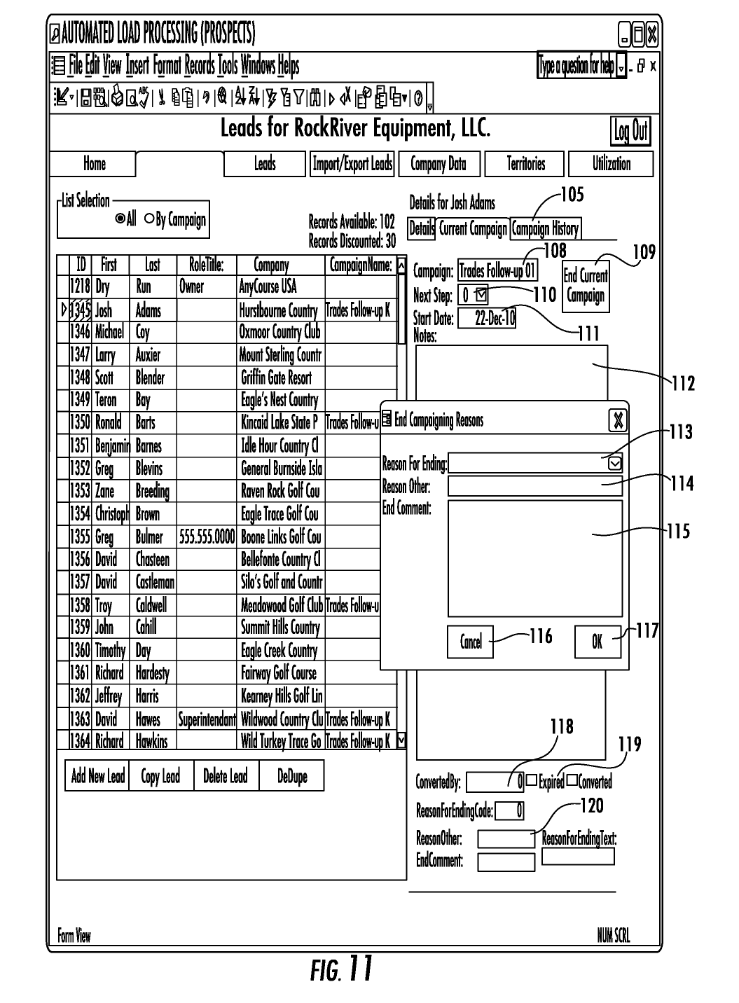

FIG. 10 is a screen shot of the software according to one embodiment of the present disclosure related to leads in the system. The screen shot of FIG. 10 includes a plurality of elements. A List Selection Field 98 selects whether lists are to be presented for a particular campaign or whether all lists are to be presented. A Record Count Field 99 presents a number of leads for this client and a number of how many of leads are discounted. A Lead List 100 presents names of the leads. In a particular embodiment, when one of the leads included in the lead list 100 is highlighted, details for the selected lead appear, in the current example, at a right side of the screen.

A “DeDupe” (“deduplicate”) Button 101 highlights potentially duplicate records of leads and enables users to select which of the leads to keep. A Delete Lead Button 102 removes a lead from the Lead List 100. A Copy Lead Button 103 creates a copy of a selected lead. Enabling such copying facilitates adding a new lead that, for example, may be with a same company as an existing lead. A New Lead Add Button 104 creates a new lead record to receive information about a new lead. Information Tabs 105 include a Details Tab (i.e., to enable the user to see all the data or details for a given lead), a Current Campaign Tab (i.e., to enable the user to view all the contacts for the current campaign), and a Campaign History Tab (i.e., to enable the user to view all the contacts for completed campaigns). When the Details Tab is selected, as shown in FIG. 10, details for the currently selected lead are displayed in a Details Area 107 that, in the example of FIG. 10, appear to the right of the screen. Note that a Test Case Field 106 enables one or more dummy leads to be included in a campaign to test the campaign design. If the Test Case Filed 106 is checked, the displayed lead is not a real lead.

FIG. 11 is a screen shot of the software according to one embodiment of the present disclosure related to Leads for a Client (e.g., RockRiver Equipment, LLC). The screen shot of FIG. 11 includes a plurality of elements. As previously described with reference to FIG. 10, Tabs 105 include a Details Tab (i.e., to enable the user to see all the data or details for a given lead), a Current Campaign Tab (i.e., to enable the user to view all the contacts for the current campaign), and a Campaign History Tab (i.e., to enable the user to view all the contacts for completed campaigns). When the current campaign tab is selected, as shown in FIG. 11, a Campaign Drop Down Box 108 enables selection of a current campaign for this lead (if this selection has not already been made). The End Current Campaign Button 109 allows the user to choose to end the campaign. If the End Current Campaign Button 109 is selected, an end campaign reason screen may be displayed.

A Next Step Field 110, which in one embodiment has a default value of 0, is incremented as steps are completed. However, a user may select to over-ride the next step to be performed. A Start Date Field 111 is the date the current campaign has begun is started for the current lead. A Notes Field 112 lists every step completed for the current campaign for the current lead. A Reason For Ending Field 113 enables a user to select from a finite list a reason for which the current campaign is being ended. Options may include “Not Ended,” “Converted to Prospect,” “Already a Customer,” “Add to Mailing List,” “Back Burner,” “Referrer,” Bad Email Address,” “Left the company,” “No Interest,” “Bad Data,” “Expired,” “Exceeded ‘Other Results,’” “Allowance,” or “Other.” An If Other Field 114 enables a description of the other reason for ending the current campaign to be specified. An End Comment Field 115 enables the user ending the campaign to enter user comments. A Cancel Button 116 enables a user to terminate an “end campaign” operation to abort the end campaign process. An OK Button 117 completes the closing of the current campaign for the current lead. An Expired Field 119 enables a user to check whether the ending of the campaign was a result of the campaign ending because of lack of response or because the campaign ended with a positive result. A Reason Other Field 120 reproduces reasons for the end of the campaign that may have been entered in the if Other Field 114 if other reasons were provided for the end of the campaign.

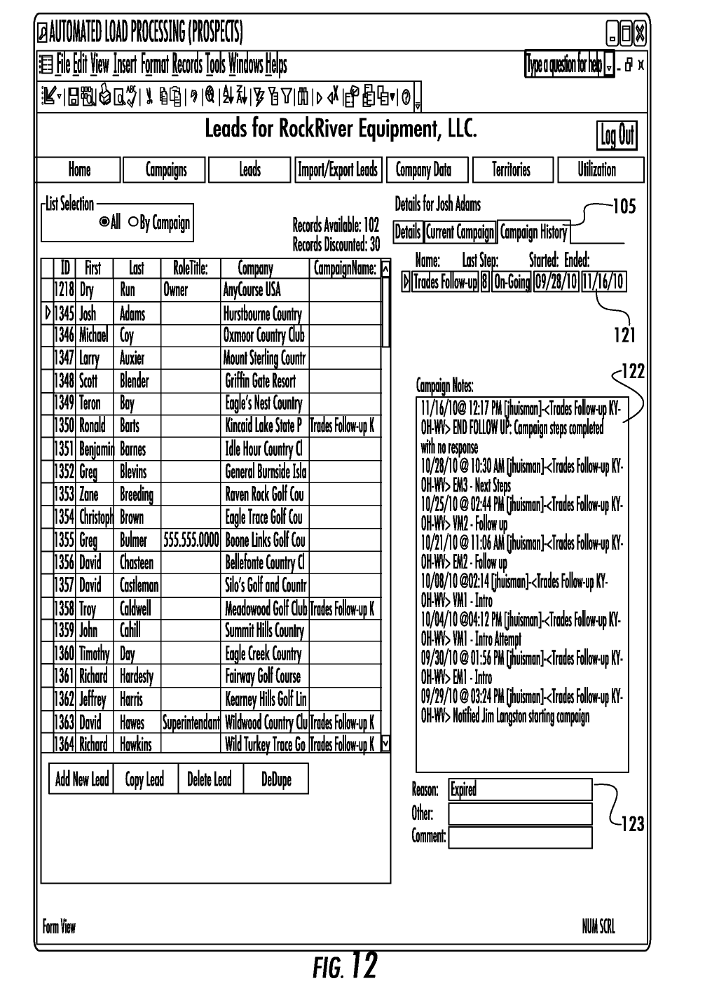

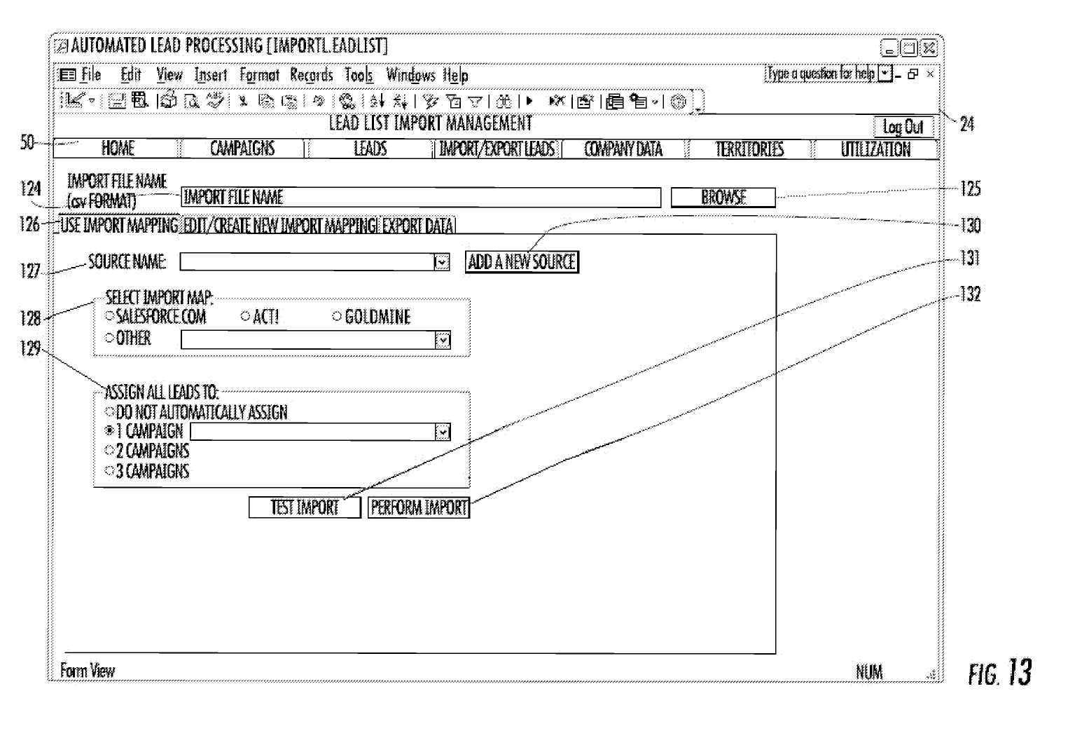

FIG. 12 is a screen shot of the software according to one embodiment of the present disclosure related to leads for a client (e.g., RockRiver Equipment, LLC). The screen shot of FIG. 12 includes a plurality of elements. As previously explained, Tabs 105 include a Details Tab (i.e., to enable the user to see all the data or details for a given lead), a Current Campaign Tab (i.e., to enable the user to view all the contacts for the current campaign), and a Campaign History Tab (i.e., to enable the user to view all the contacts for completed campaigns). When a campaign history tab is selected, as shown in FIG. 12, an historical campaigns table is presented that lists all the campaigns in which the current lead has been involved. A campaign notes field 122 presents all notes for the current lead to be presented. A reason field 123 enables the user to access, for a selected item in the historical campaign field, the reason for ending the campaign and any comments associated with the ending of the campaign.

FIG. 13 is a screen shot of the software according to one embodiment of the present disclosure related to leads list import management. The screen shot of FIG. 13 includes a plurality of elements. An Import File Name Field 124 enables a user to enter the name of the file that is to be imported. A Browse Button 125 enables the user to search the computer to find the file that is to be imported. Tabs 126 enable a user to perform a number of functions, including: 1) to use an import map that has already been created; 2) to edit or create an import map to use; and 3) to use a map to export the data. A Use Import Mapping Tab 127 enables a user to view the source of the data to be specified (this is different than the file name or map as there may be more than one of those from a given source). For example, a trade show (e.g., an “XYZ Show”) may yield contacts both in the form of business cards and an electronic list that are to be entered. A Source Name Field 128 enables an import map is selected. According to a particular embodiment, there are pre-defined maps for importing information from contact management programs as “SalesForce.com, “ACT!,” and “Goldmine.” The Other Check Box 129 allows for the use of user-defined maps, which may be created by using an edit/create new import mapping function (shown in a tab in FIG. 13) in importing data.

An Assign All Leads Field 129 enables leads to automatically be assigned to particular campaigns as the data is imported. However, in order to allow for testing of multiple campaigns, the leads may be randomly assigned to multiple campaigns. Assigning leads randomly to multiple campaigns may allow clients to test campaigns to determine which campaigns may work best. Available campaigns may be displayed in drop-down list boxes.

An Add A New Source Button 130 adds sources to the drop-down list. A test import button 131 enables the user to attempt to import the data from the import file using the selected map without actually entering any of the data into the system. If there are any errors, they are flagged to be corrected before any contamination can take place. A Perform Import Button 132 imports the data from the import file using the selected map.

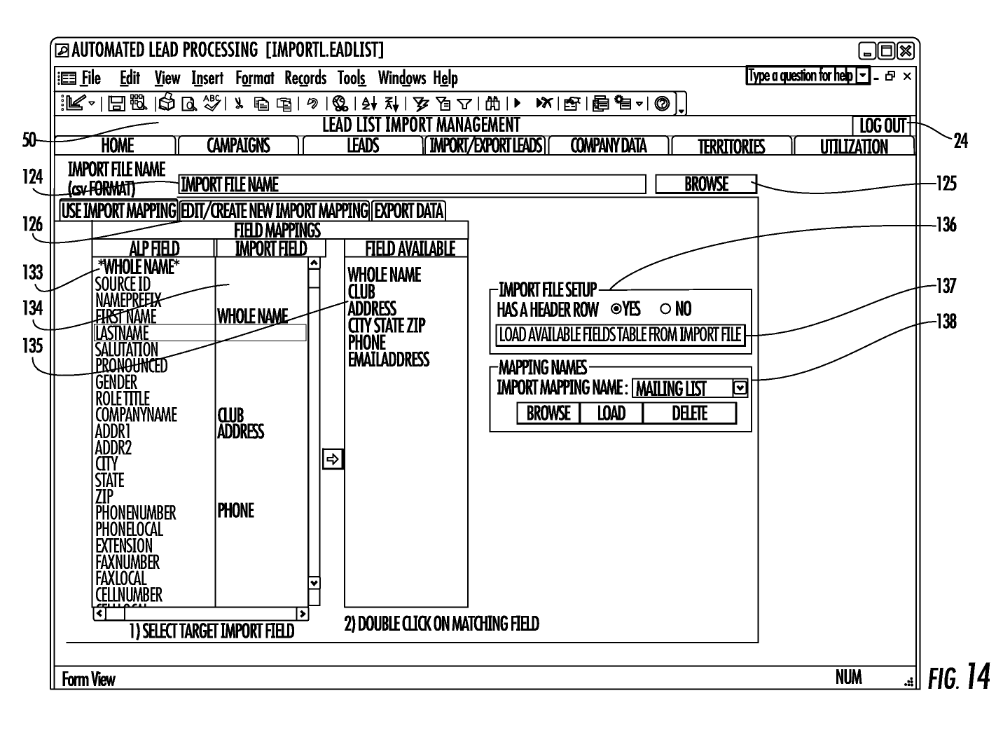

FIG. 14 is a screen shot of the software according to one embodiment of the present disclosure related to leads list import management. The screen shot of FIG. 14 includes the following elements. An ALP Field 133 displays fields that are available in the ALP application to into which the data may be mapped. In a particular embodiment, to create a mapping, a user selects a destination field in the ALP Field 133 column and then double-clicks on the field to be mapped in a Fields Available Column 135 that shows the fields that are available in the file provided by the user to be imported. A result is displayed in the Import Field Column 134. The Import Field Column 134 displays the fields from the user's data that have been mapped to the ALP fields. An Import File Setup 136 field enables retrieval of header row information and loads the header row information into the Fields Available Column 135. A Load Available Fields Button 137, when selected, loads data into the Fields Available Column 135. An Import Mapping Name Field 138 enables the name of the mapped file to be created after a save button (not shown in FIG. 14) is selected. After the data is saved, it is then available for future access from the drop-down box, and the file can be retrieved and loaded. When the file is no longer needed, it can be deleted.

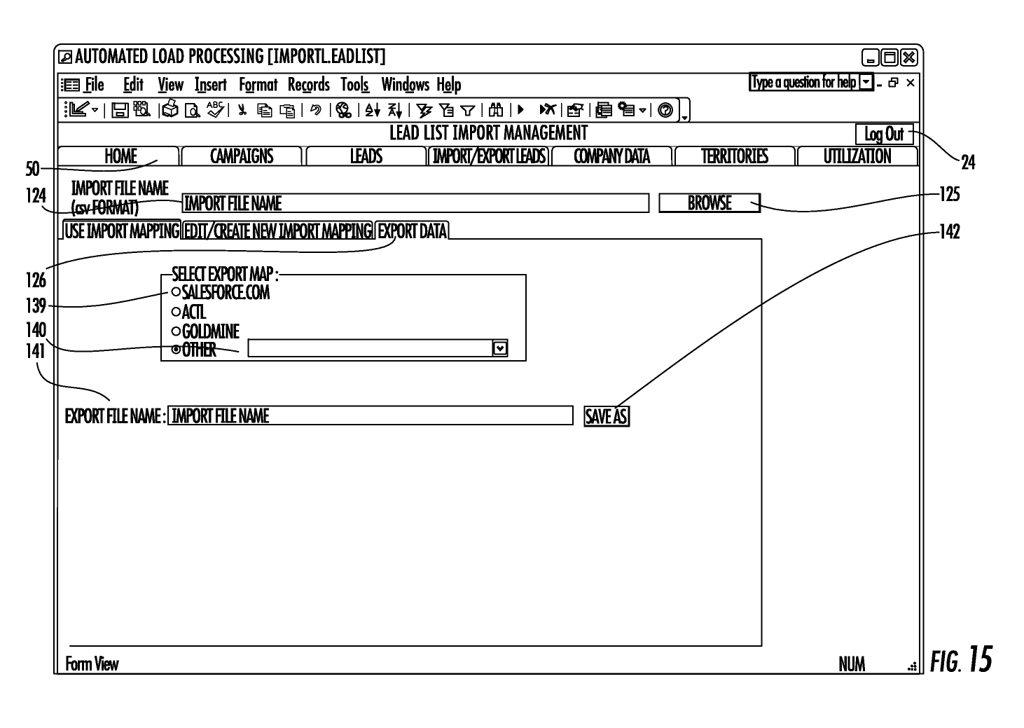

FIG. 15 is a screen shot of the software according to one embodiment of the present disclosure related to leads list import management. The screen shot of FIG. 15 includes a plurality of elements. A Select Export Map Field 139 enables a particular export map to be selected. In a particular embodiment, there may be pre-defined export maps for exporting information to such contact management programs as “SalesForce.com,” “ACT!,” and “Goldmine.” An Other Checkbox 140 enables use of a user-defined maps (created by invoking the edit/create new mapping tab, as shown in FIG. 15) for exporting data to programs other than those for which a pre-defined export map exists. An Export File Name Field 141 enables the user to the user to specify the name of the file to be exported. A Save As Button 142 saves the data after first determining the appropriate format such as .csv, tab-delimited, comma-separated or XML.

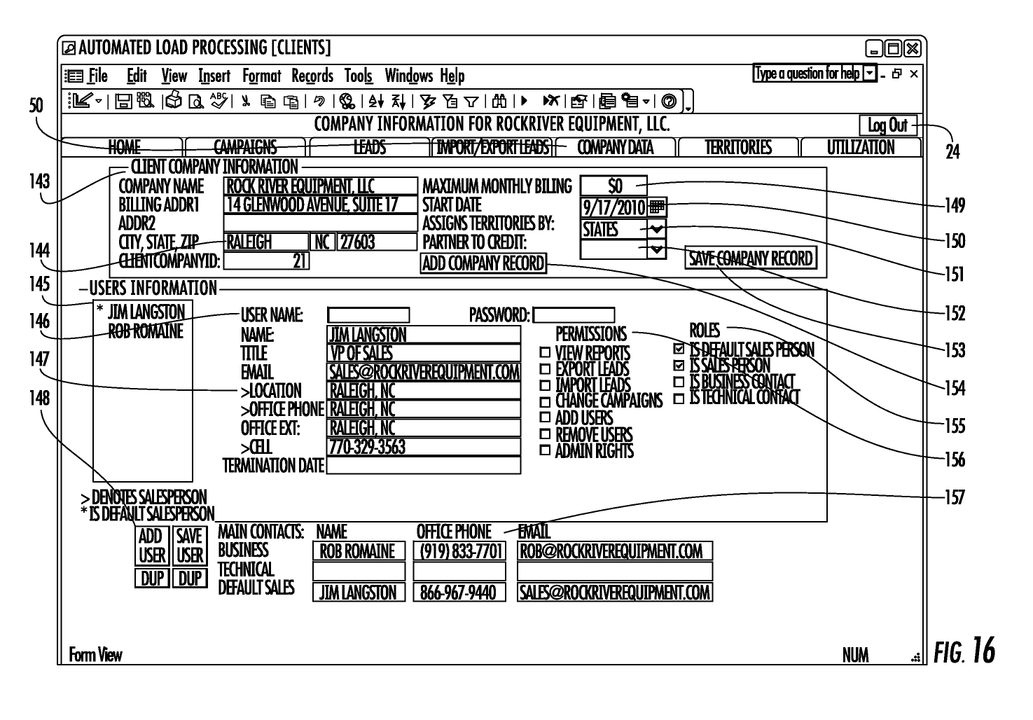

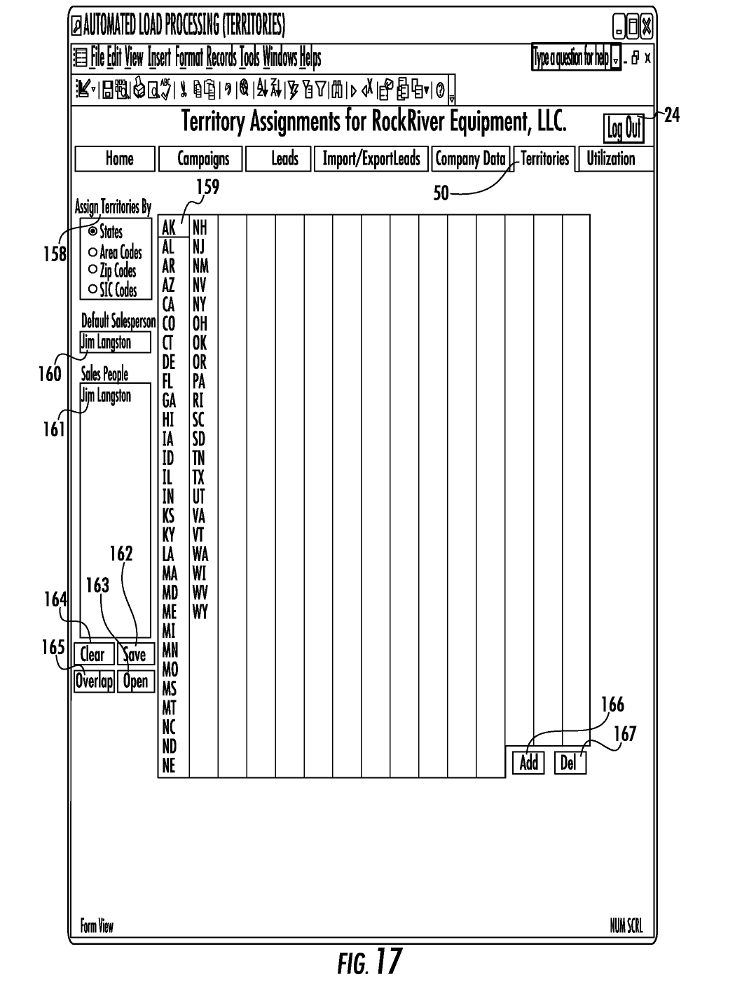

FIG. 16 is a screen shot of the software according to one embodiment of the present disclosure related to company information (e.g., for RockRiver Equipment, LLC). The screen shot of FIG. 16 includes a plurality of elements. A Client Company Information Field 143 includes multiple fields usable to maintain the information about a client company. A City Field 144 enables a name of the client's city to be entered. In a particular embodiment, certain may be shaded to signify that the field may be automatically filled by parsing any one or more of the city, state, and ZIP code information. For example, inputting the zip code may automatically fill the City Field 144. A Users Information List Box 145 presents a list of the users in the system. As shown in FIG. 16, according to a particular embodiment, there may be two prefixing characters. If a name is preceded by a “>” that person is listed as a salesperson for the company. If the name is preceded by an asterisk “*”, that person is designated as the “Default Salesperson.” The Default Salesperson is the one to whom all leads are assigned that may not otherwise be assigned to a different salesperson.

User Fields 146 are used to gather additional information about the user selected in the User Information Field 145. Location Fields 147, in a particular embodiment, include three fields used in creating emails to compose the email signature of the person. These fields are indicated by the “>” character. Add/Save/Delete Buttons 148 are used, respectively, to add, save and delete users. The Add/Save/Delete Buttons 148 also include a “dup” (duplicate) button to copy an entire user record that may be edited to complete an entry.

A Maximum Monthly Billing Field 149 may be used to indicate the maximum monthly billing this client is willing to undertake. If the monthly bill gets to this level, the business contact of the client is notified and no further activity occurs until the next month unless the limit is over-ridden. A Start Date Filed 150 is used to specify the day that the client becomes a customer. An assigns territories by Drop-Down Menu 151 enables selection of different types of information that may be used to assign territories to salespeople. For example, prospects may be assigned to sales people according to state, area code, ZIP code, or SIC code. A partner to credit drop-down menu allows the use of marketing partners who will afford credit for any activity that occurs with this client.

A Save Company Record Button 153 updates the client company database with new data populated into the fields of the screen shot of FIG. 16. An Add Company Records Button 154 creates a new entry in the client company database. A plurality of Roles Checkboxes 155 enable the specification of roles within ALP for the user highlighted in the user information list box 145. According to a particular embodiment, a user may have multiple roles. A plurality of Permissions Checkboxes 156 enable designation of what functionality the user highlighted in the User Information List Box 145 may access. For example, only users with administrator rights have access to this screen and the functions the screen enables. A plurality of Main Contacts Fields 157 are presented. According to a particular embodiment, the Main Contacts Fields 157 may not be updated from this screen, but presenting the main contacts data makes it easy to see which user holds which role for the selected client without having to select each of the individual users to determine the users' roles.

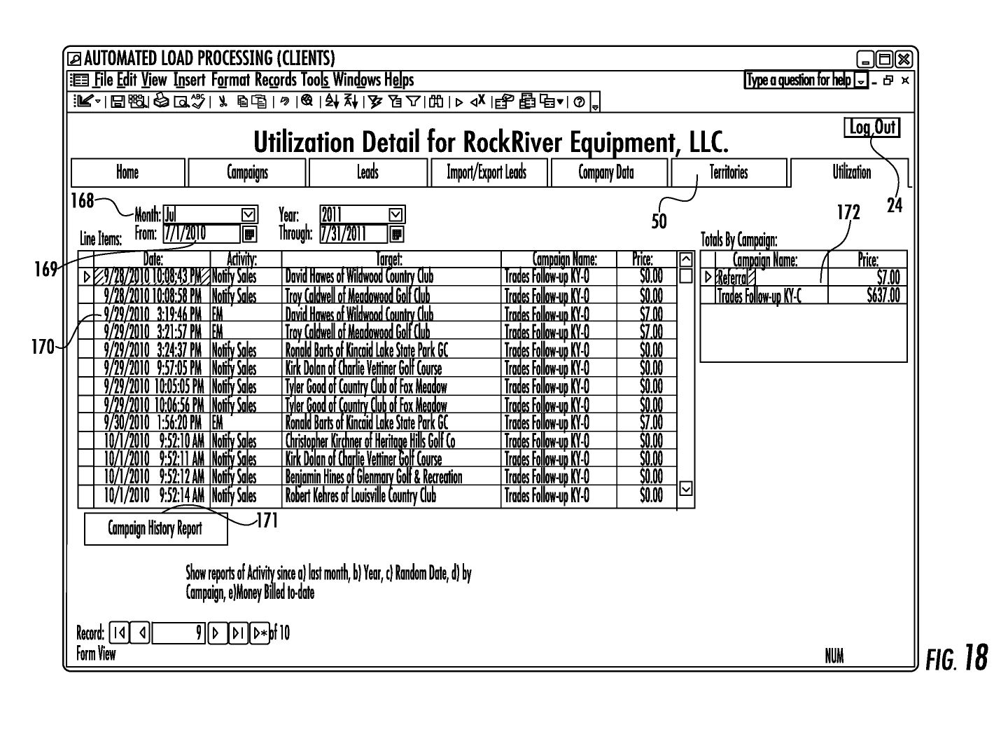

FIG. 17 is a screen shot of the software according to one embodiment of the present disclosure related to territory assignments for a company (e.g., for RockRiver Equipment, LLC). The screen shot of FIG. 17 includes a plurality of elements. A plurality of Assign Territories Radio Buttons 158 enable selection of which territories are to be displayed in an Available Territory Grid 159. The Available Territory Grid 159 shows all the states, area codes, or other territories that are available. Territories may also be specified by ZIP codes, SIC codes, or other types of territories that the client may specify. From a Salesperson List 161, a Default Salesperson 160 may be selected. Selecting a default salesperson causes all the territories in the Available Territory Grid 159 to be highlighted that are assigned to that salesperson. Individual territories may be selected or deselected to assign the territory to be covered by that salesperson.

A Save Button 162 saves the currently displayed territory mapping associated with the highlighted salesperson. An Open Button 163 displays all territories with which no salesperson specifically has been associated. A Clear Button 164 deselects all the territories associated with the highlighted salesperson. An Overlap Button 165 displays all territories that are currently associated with more than one salesperson. An Add Button 166 allows the addition of territories. In the case of the states and area codes, the lists are complete. However, for ZIP code and SIC codes, there are too many territories to list in the grid, so the client can list only those that are appropriate. A Delete Button 167 deletes codes from the territory grid that are not needed.

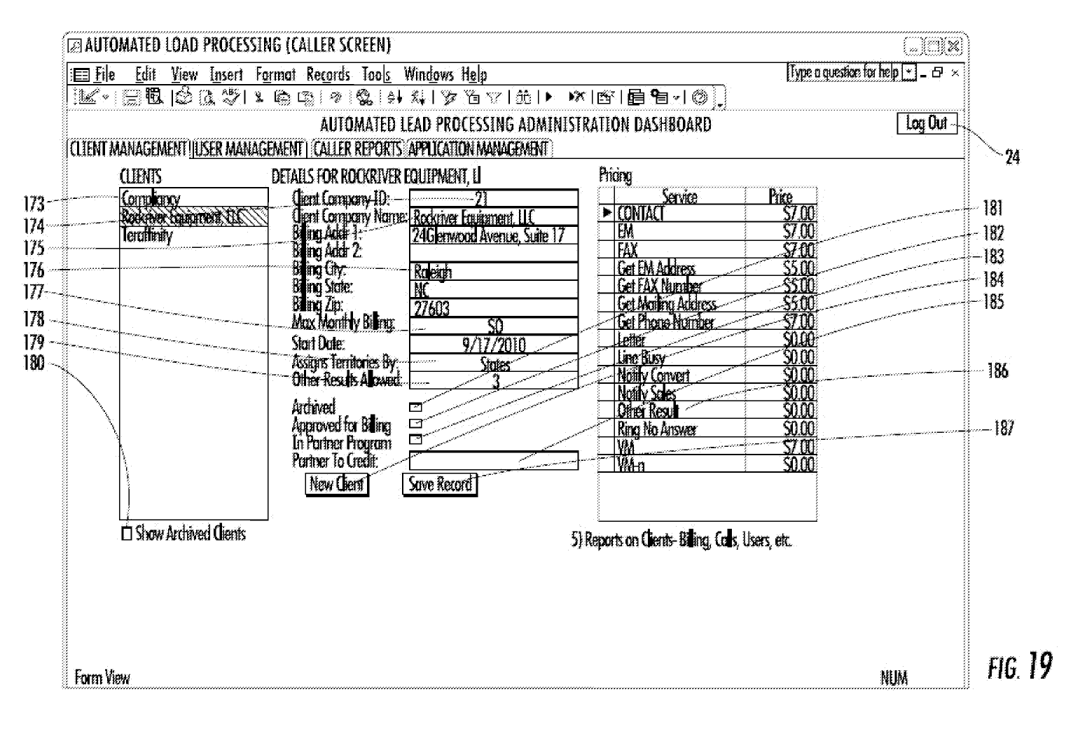

FIG. 18 is a screen shot of the software according to one embodiment of the present disclosure related to utilization detail for the company (e.g., for RockRiver Equipment, LLC). The screen shot of FIG. 18 includes a plurality of elements. Month And Year Dropdown Boxes 168 allow a user to get a summary listing of every activity that has been completed during that specific month and year, and to see the summary of costs for that selected month. From/Through Fields 169 (and their associated calendar buttons) allow a user to get a summary listing of every activity that has been completed during that specific date period and to see the summary of costs. The Line Items Table 170 lists every activity that has been completed during the selected month. A Campaign History Report Button 171 cause a PDF file report of the same information to be created. The PDF report can be printed or emailed as desired. A Totals By Campaign Table 172 provides a summary of costs by campaign during the specified time interval.

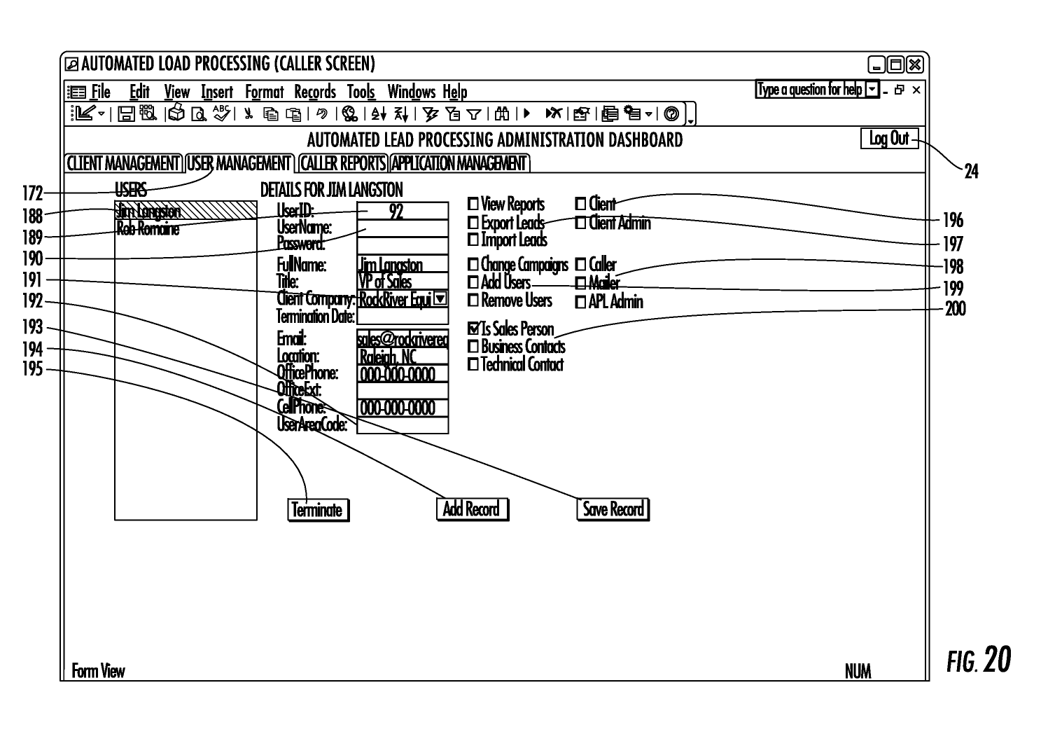

FIG. 19 is a screen shot of the software according to one embodiment of the present disclosure related to an automated lead processing administration dashboard. The screen shot of FIG. 19 includes a plurality of elements. A Clients List 173 lists all clients for whom parameters are to be managed. For a client entered into the program, the client can be selected from the Clients List 173. A Client Company ID 174 is a unique identifier created by the program for each client company. Client Company Information Fields 175 are configured to receive company address information. A City Field 176 may be automatically parsed to delineate separate city, state, and ZIP code information into separate fields. A Maximum Monthly Billing Field 177 enables a company to sign up for a monthly not-to-exceed dollar amount. When the processing gets to a point where that much money has been spent on the client's behalf, the system stops scheduling events for the rest of the month and notifies the client. A Territory Allocation Field 178 enables the specification of how leads are allocated to salespeople by state, ZIP code, area code, or SIC code.

Because not every sales call goes through, an Other Results Allowed Field 179 provides a predetermined number of “free” events that are not charged to the client. For example, if a call is made by ALP, but the prospect is on vacation until next week, there is no point in leaving a message. The system handles that case and treats it as an “other result” at no charge. “Line busy” and “ring-no-answer” are other examples of similar events. Up to N free items are allowed per prospect. The cap of ‘N’ is set here on a client-by-client basis.

A Show Archived Client Field 180 enables non-current clients to be listed in the Client List 173. Typically, only active clients are displayed in the clients list. However, if the Show Archived Client Field 180 is selected, clients that are no longer active are displayed along with current clients. An Archived Check Box 181, when selected, identifies a client for removal from active status. An Approved For Billing Checkbox 182 enables a client to be designated as not having to pay up front for services. An in Partner Program Field 183 enables a client to be identified as being a partner to whom a commission may be paid for paying clients that the partner has recruited to ALP. A client is identified as a partner when the in Partner Program Button 183 is checked.

A New Client Button 184, when selected, clears all these fields and prepares a new client record to be created. A Partner To Credit Field 185 enables a client to be identified for receiving a commission when the In-Partner Program Box 183 is selected.

A Pricing Table 186 lists actions that may result when prices that are charged for those actions. For example, for actions chargeable to a new client, values in the pricing table 186 default to standard pricing. However, the prices listed in the pricing table may be individually modified for each client or for each activity level. A Save Record Button 187 saves information entered for the current client, thereby updating the client information as needed.

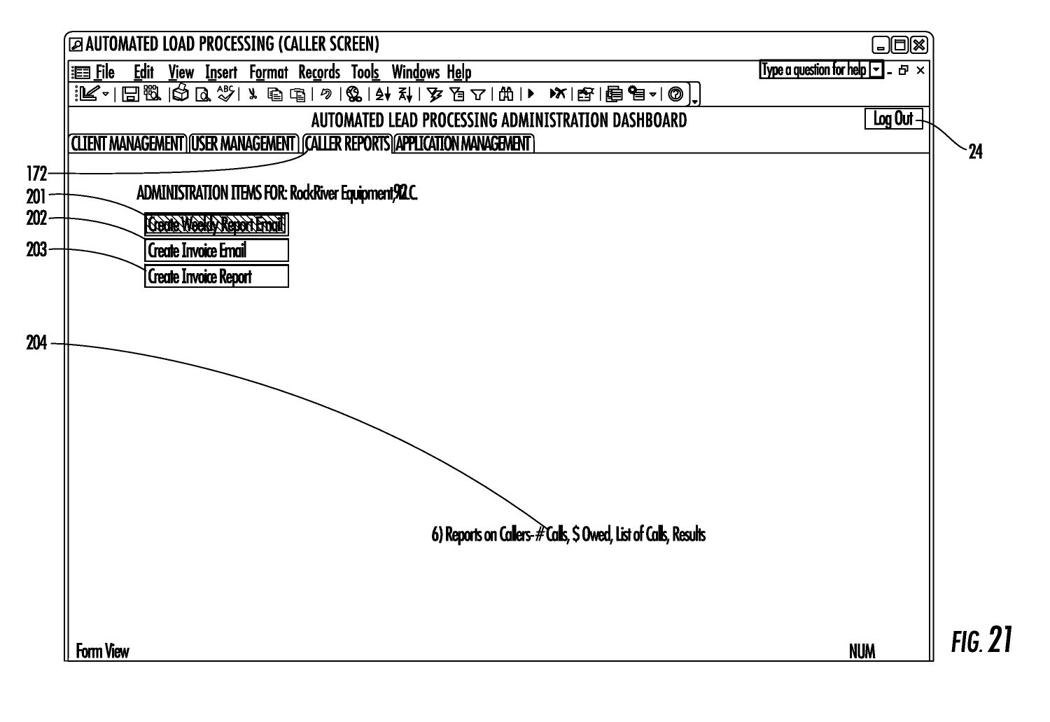

FIG. 20 is a screen shot of the software according to one embodiment of the present disclosure related to an automated lead processing administration dashboard. The screen shot of FIG. 20 includes a plurality of elements. A Users List 188 includes a list of users already created for the selected client company. A User Identifier (ID) 189 is a unique identifier created by the program for each client company. User Information Fields 190 are configured to receive other information about the user, such as full name, title, contact information, and other information. A User Assignment Dropdown Menu 191 enables an assignment of a user among different client companies. A User Area Code Field 192 is used for ALP callers. Thus, for example, when calling prospects whose area code is the same as the user's area code, the area code prefix is not used in placing the call. A Save Record Button 193 saves the information for this user, updating it if necessary. An Add Record Button 194 clears all the fields, preparing for creation of a new user record. A terminate record button 195 is used to indicate that a certain user is no longer associated with the client. Once the Terminate Record Button 195 is selected, leads are no longer assigned to this salesperson or calls are not sent to this ALP person.

Client Permission Checkboxes 196 and 197 assign permissions to the user for the client account. Permissions Checkboxes 198 provide permissions to the user for the ALP account. Add User Checkboxes 199 provide permissions to the User for the ALP or Client account. Role Checkboxes 200 provide clients may be used to identify when a particular user has a particular role in the contact management process.

FIG. 21 is a screen shot of the software according to one embodiment of the present disclosure related to an ALP administration dashboard. The screen shot of FIG. 21 includes a plurality of elements. A Create Weekly Report Email Button 201 causes the creation of two .RTF files that list all the activity by each prospect to date. The first report is for prospects that are still active. The second report is for prospects that have been completed, either by converting them or by managing the entire contact management process with them. These files are automatically attached to an email that may be sent to the main business contact of the client. A Create Invoice Email Button 202 causes an invoice to be created as an .RTF file and attached to an email to be sent to the main business contact of the client. A Create Invoice Report Button 203 creates a similar invoice, but the invoice is prepared in Microsoft Access® format that may be converted into a .PDF file. A Reports List 204 includes a list of items that are still to be added.

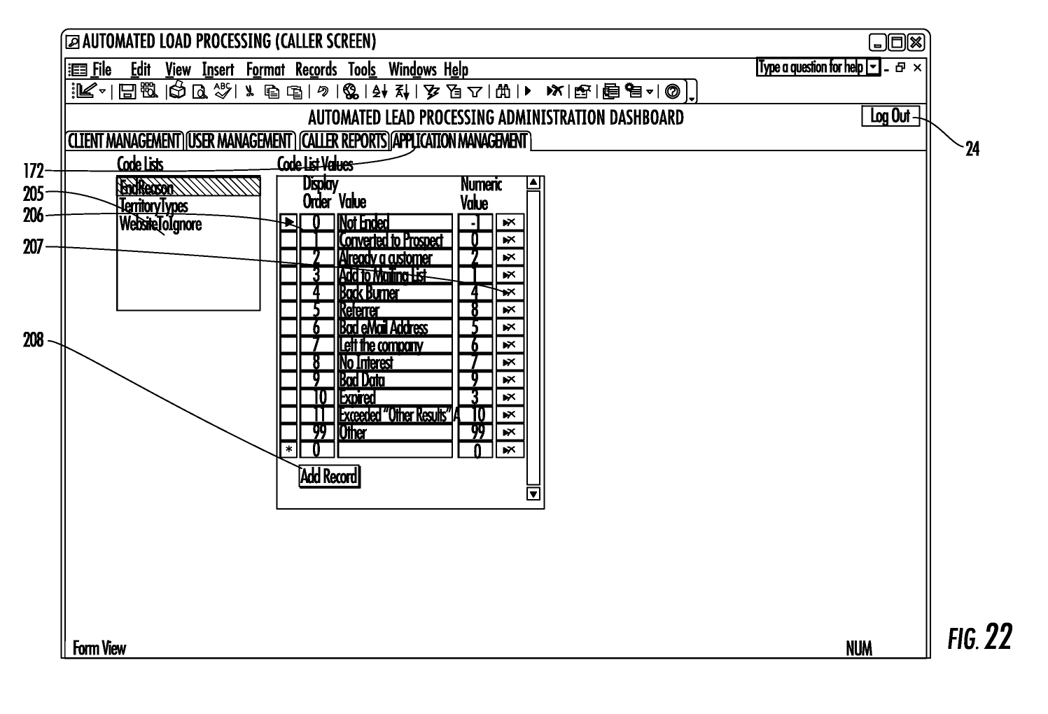

FIG. 22 is a screen shot of the software according to one embodiment of the present disclosure related to an ALP administration dashboard. The screen shot of FIG. 22 includes a plurality of elements. A Code Lists Table 205 includes a list of the code lists. According to a particular embodiment, the code lists may be edited from this same screen as depicted in FIG. 22 that can be edited from here. A Code List Values Table 206 is a list of what fields are included in the code lists, including display order, text value, and numeric value. Delete (“X”) Buttons 207 enable the user to delete selected code list values. An Add Record Button 208 enables a user to add new code list values.

It is to be appreciated that any of the elements and features described herein may be combined with any one or more other elements and features.

While the disclosure has been has been described herein in reference to specific aspects, features and illustrative embodiments of the disclosure, it will be appreciated that the utility of the disclosure is not thus limited, but rather extends to and encompasses numerous other variations, modifications and alternative embodiments, as will suggest themselves to those of ordinary skill in the field of the present disclosure, based on the disclosure herein. Any of various elements or features recited herein is contemplated for use with other features or elements disclosed herein, unless specified to the contrary. Correspondingly, the disclosure as hereinafter claimed is intended to be broadly construed and interpreted, as including all such variations, modifications and alternative embodiments, within its spirit and scope.

What is claimed is:

1. A computer-implemented automated lead processing system for lead development, the system comprising:
a lead set comprising lead data for one or more potential leads; and
a table-driven customizable campaign interface for selection of a sequence of lead development steps applicable to said one or more potential leads, to initiate automated processing of said lead data in said lead set for said one or more potential leads, and to generate a monitoring record in a database of the system of said sequence of lead development steps, wherein the system is adapted on occurrence of at least one predefined trigger event to signal at least one action to be taken relating to the sequence of lead development steps, and wherein the system is adapted to display a status determination on said interface for said one or more potential leads.

2. The system of claim 1, wherein said lead data comprises any of a name, a pronunciation of the name, a gender, an email address, a phone number, a phone extension, a facsimile number, a physical address, a web address, a title or role, a company, a salutation, a local time, an assistant's name, an assistant's phone number, an assistant's phone extension, and an assistant's email address.

3. The system of claim 1, wherein said lead development steps comprise any of an email, a call, a message, a voicemail, a letter, a facsimile, a notification to client, a sending of information, an addition of said one or more potential lead to a mailing list, a text message, and a referral initiation.

4. The system of claim 1, wherein said lead development steps are personalized to the particular lead.

5. The system of claim 1, wherein the system is adapted to display the monitoring record on said interface for said one or more potential leads.

6. The system of claim 1, wherein the system is adapted to display the monitoring record on a client's interface for said one or more potential leads.

7. The system of claim 1, wherein the system is adapted to display the status determination on a client's interface for said one or more potential leads

8. The system of claim 1, wherein the at least one predefined trigger event comprises any of an elapse of time, an inquiry from a client, a communication from said one or more potential leads, a news event, and a referral communication.

9. The system of claim 1, wherein the at least one action to be taken comprises any of executing one or more of said lead development steps, delaying one or more of said lead development steps, rescheduling one or more of said lead development steps, reselecting one or more of said lead development steps, initiating a referral lead, updating said lead data for said one or more potential leads, initiating a search of information for said one or more potential leads, reconciling said lead data for said one or more potential leads, and terminating said one or more potential leads.

10. A computer-implemented method for automated lead processing, the method comprising:
inputting on said computer a lead set comprising lead data for one or more potential leads;
generating on an interface of said computer a table-driven customizable campaign on the interface related to said lead set; and
selecting on said interface a sequence of lead development steps applicable to said one or more potential leads, wherein said computer is adapted on occurrence of at least one predefined trigger event to signal at least one action to be taken relating to the sequence of lead development steps, and wherein the computer is adapted to display a status determination on said interface for said one or more potential leads.

11. The method of claim 10, further comprising executing said campaign on said lead data in said lead set for said one or more potential leads individually according to said sequence of lead development steps.

12. The method of claim 10, wherein the computer is programmatically arranged to generate a monitoring record in a database of the computer of the sequence of lead development steps.

13. The method of claim 10, further comprising querying the database of the computer to display the status determination on said interface for said one or more potential leads.

14. The method of claim 10, further comprising updating said lead data for said one or more potential leads.

15. The method of claim 10, further comprising initiating a search of information for said one or more potential leads.

16. The method of claim 10, further comprising reconciling said lead data for said one or more potential leads.
